(19) United States
(12) Patent Application Publication
(10) Pub. No.: US 2013/0265504 A1
(43) Pub. Date: Oct. 10, 2013

(54) TELEVISION AND ELECTRONIC APPARATUS

(71) Applicant: KABUSHIKI KAISHA TOSHIBA, Tokyo (JP)

(72) Inventors: Yuki SATO, Ome-shi (JP); Shigeki NISHIYAMA, Hino-shi (JP); Hirofumi MORITA, Higashiyamato-shi (JP); Jun MORIMOTO, Yokohama-shi (JP); Yuji SASAKI, Yokohama-shi (JP); Takuya MATSUDA, Yokohama-shi (JP)

(73) Assignee: KABUSHIKI KAISHA TOSHIBA, Tokyo (JP)

(21) Appl. No.: 13/735,855

(22) Filed: Jan. 7, 2013

(30) Foreign Application Priority Data
Apr. 6, 2012 (JP) 2012-087767

(51) Int. Cl. H04N 5/645

(52) U.S. Cl. CPC H04N 5/645
USPC 348/836

(57) ABSTRACT

According to one embodiment, an electronic apparatus includes a display, a rear cover, and a front mask. The rear cover is configured to cover a rear surface of the display. The front mask is configured to be exposed to an outside and includes an opening and a supporter. The opening is configured to expose a front surface of the display. The supporter is configured to support the display and includes a first portion and a second portion. The first portion is configured to face a side surface of the display. The second portion protrudes from the first portion toward the rear cover. The second portion is closer to the rear cover than the rear surface of the display.

### CROSS-REFERENCE TO RELATED APPLICATIONS

This application is based upon and claims the benefit of priority from Japanese Patent Application No. 2012-087767, filed Apr. 6, 2012; the entire contents of which are incorporated herein by reference.

### FIELD

Embodiments described herein relate generally to electronic apparatuses including televisions.

### BACKGROUND

An electronic apparatus has been proposed which includes a housing having a display therein.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary front view illustrating a television according to a first embodiment;

FIG. 2 is an exemplary side view illustrating the television illustrated in FIG. 1;

FIG. 3 is an exemplary cross-sectional view illustrating a display unit of the television illustrated in FIG. 1;

FIG. 4 is an exemplary exploded cross-sectional view illustrating the display unit illustrated in FIG. 3;

FIG. 5 is an exemplary cross-sectional view illustrating a display unit of a television according to a second embodiment;

FIG. 6 is an exemplary perspective view illustrating an electronic apparatus according to a third embodiment;

FIG. 7 is an exemplary plan view illustrating the internal structure of the electronic apparatus illustrated in FIG. 6;

FIG. 8 is an exemplary plan view illustrating the internal structure of the electronic apparatus illustrated in FIG. 6;

FIG. 9 is an exemplary cross-sectional view illustrating the electronic apparatus illustrated in FIG. 6;

FIG. 10 is an exemplary cross-sectional view illustrating an example of the electronic apparatus illustrated in FIG. 6;

FIG. 11 is an exemplary perspective view illustrating in detail an example of a portion of a rear cover illustrated in FIG. 10;

FIG. 12 is an exemplary perspective view illustrating in detail an example of a portion of a front mask illustrated in FIG. 10;

FIG. 13 is an exemplary perspective view illustrating in detail an example of another portion of the rear cover illustrated in FIG. 10;

FIG. 14 is an exemplary perspective view illustrating in detail an example of another portion of the front mask illustrated in FIG. 10;

FIG. 15 is an exemplary perspective view illustrating an example of the rear cover illustrated in FIG. 10;

FIG. 16 is an exemplary perspective view illustrating an example of the front mask illustrated in FIG. 10;

FIG. 17 is an exemplary perspective view illustrating in detail an example of still another portion of the front mask illustrated in FIG. 10;

FIG. 18 is an exemplary cross-sectional view illustrating a modification of the electronic apparatus illustrated in FIG. 10;

FIG. 19 is an exemplary cross-sectional view illustrating an electronic apparatus according to a fourth embodiment;

FIG. 20 is an exemplary cross-sectional view illustrating an electronic apparatus according to a fifth embodiment;

FIG. 21 is an exemplary cross-sectional view illustrating an electronic apparatus according to a sixth embodiment;

FIG. 22 is an exemplary cross-sectional view illustrating an electronic apparatus according to a seventh embodiment;

FIG. 23 is an exemplary cross-sectional view illustrating an electronic apparatus according to an eighth embodiment;

FIG. 24 is an exemplary cross-sectional view illustrating an electronic apparatus according to a ninth embodiment;

FIG. 25 is an exemplary cross-sectional view illustrating an electronic apparatus according to a tenth embodiment;

FIG. 26 is an exemplary perspective view illustrating a front mask of an electronic apparatus according to an eleventh embodiment;

FIG. 27 is an exemplary enlarged view illustrating a drawing portion illustrated in FIG. 26;

FIG. 28 is an exemplary diagram illustrating a first modification of the drawing portion illustrated in FIG. 27;

FIG. 29 is an exemplary diagram illustrating a second modification of the drawing portion illustrated in FIG. 27;

FIG. 30 is an exemplary exploded perspective view illustrating an electronic apparatus according to a twelfth embodiment;

FIG. 31 is an exemplary plan view illustrating a rear cover illustrated in FIG. 30;

FIG. 32 is an exemplary cross-sectional view illustrating an electronic apparatus according to a thirteenth embodiment;

FIG. 33 is an exemplary cross-sectional view illustrating an electronic apparatus according to a fourteenth embodiment;

FIG. 34 is an exemplary cross-sectional view illustrating an electronic apparatus according to a fifteenth embodiment;

FIG. 35 is an exemplary cross-sectional view illustrating an electronic apparatus according to a sixteenth embodiment;

FIG. 36 is an exemplary cross-sectional view illustrating an electronic apparatus according to a seventeenth embodiment;

FIG. 37 is an exemplary cross-sectional view illustrating an electronic apparatus according to an eighteenth embodiment;

FIG. 38 is an exemplary cross-sectional view illustrating an electronic apparatus according to a nineteenth embodiment;

FIG. 39 is an exemplary cross-sectional view illustrating an electronic apparatus according to a twentieth embodiment; and

FIG. 40 is an exemplary diagram illustrating modifications of the first to twentieth embodiments.

### DETAILED DESCRIPTION

Various embodiments will be described hereinafter with reference to the accompanying drawings.

In general, according to one embodiment, an electronic apparatus comprises a display, a rear cover, and a front mask. The display comprises a front surface, a rear surface, and a side surface. The rear cover is configured to cover the rear surface of the display. The front mask is configured to be exposed to an outside and comprises an opening and a supporter. The opening is configured to expose the front surface of the display. The supporter is configured to support the display and comprises a first portion and a second portion. The first portion is configured to face the side surface of the display. The second portion protrudes from the first portion toward the rear cover. The second portion is closer to the rear cover than the rear surface of the display.

Hereinafter, exemplary embodiments will be described with reference to the accompanying drawings. In the specification, for a television or an electronic apparatus, the front, rear, left, and right sides are defined based on the position of the user who uses the television or the electronic apparatus (e.g., the position where the user faces a display screen). That is, the near side (i.e., the user side or the side on which the display screen is exposed) is defined as the front side, the far side (i.e., side opposite to the display screen) as viewed from the user is defined as the rear side, the left side as viewed from the user is defined as the left side, and the right side as viewed from the user is defined as the right side.

In this specification, some components are expressed by two or more terms. Those terms are just examples. Those components may be further expressed by another or other terms. And the other components which are not expressed by two or more terms may be expressed by another or other terms.

### First Embodiment

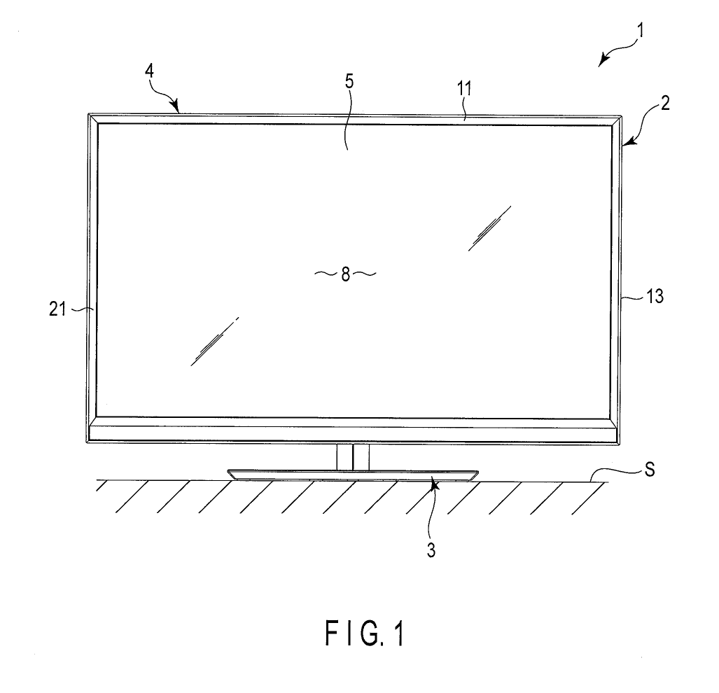

FIGS. 1 to 4 illustrate a television 1 according to a first embodiment. The television 1 is an example of an “electronic apparatus”. The television 1 includes a display unit 2 and a stand 3 (i.e., a supporter) which supports the display unit 2. The stand 3 is placed on, for example, an external mounting surface S (i.e., a mounting surface or an installation surface) and supports the display unit 2 in a rising state.

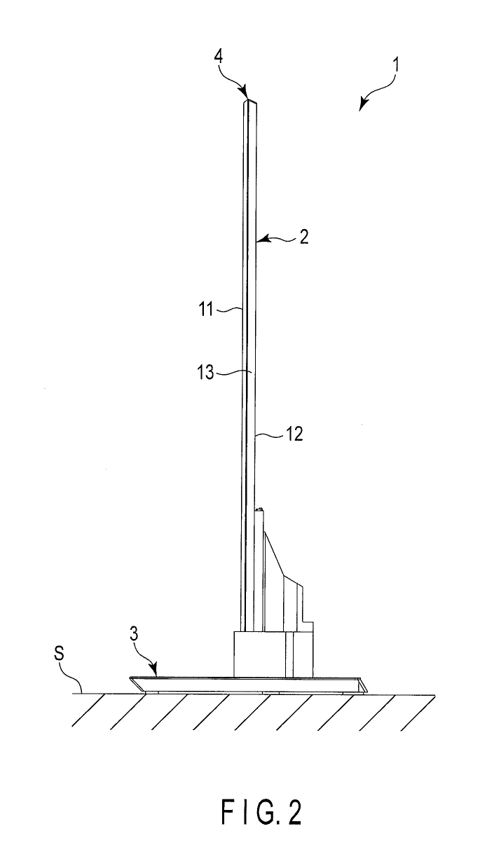

As illustrated in FIGS. 1 and 2, the display unit 2 includes a housing 4 having a flat box shape and a display unit 5 attached to (e.g., accommodated in) the housing 4. The display unit 5 includes a display 6 and a light-permeable (e.g., transparent) panel 7.

The display 6 (i.e., a display device, a display module, a display panel, a panel, a display sheet, or a sheet) includes a display screen 8 on which an image or a video is displayed. An example of the display 6 is a liquid crystal display (LCD) or an organic electro-luminescent display (OELD). The display 6 is not limited thereto, but various displays can be widely applied.

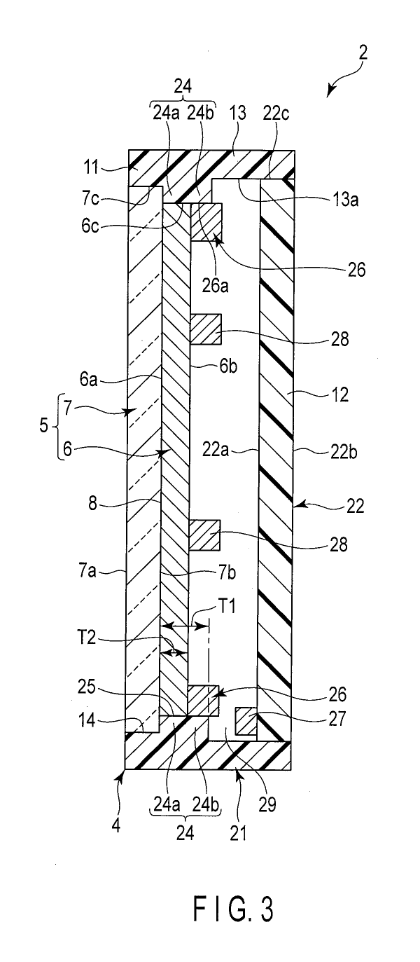

As illustrated in FIG. 3, the display 6 has, for example, a rectangular plate shape. The display 6 includes a front surface 6a (i.e., first surface), a rear surface 6b (i.e., a back surface or a second surface), and a side surface 6c (i.e., a circumferential surface or a third surface). The front surface 6a includes the display screen 8. The rear surface 6b is opposite to the front surface 6a and extends substantially in parallel to the front surface 6a. The side surface 6c extends in a direction intersecting (e.g., substantially perpendicular to) the front surface 6a and the rear surface 6b. The side surface 6c connects the circumferential end (i.e., the end or the edge) of the front surface 6a and the circumferential end (i.e., the end or the edge) of the rear surface 6b.

As illustrated in FIG. 3, the panel 7 (i.e., panel portion) faces the front surface 6a of the display 6. The size of the panel 7 is more than, for example, the size of the display 6. An example of the panel 7 is a protective panel (i.e., a protective member, a protective sheet, a sheet, or a panel) that covers the display 6. The panel 7 is made of, for example, a material with rigidity higher than that of the display 6. In this embodiment, the panel 7 overlaps the front surface 6a of the display 6 and is fixed to the front surface 6a of the display 6.

A light-permeable (e.g., transparent) adhesive portion (e.g., adhesive layer) is provided between the panel 7 and the display 6. An example of the adhesive portion is a light-permeable double-sided tape (e.g., Optical Clear Adhesion (OCA)). In this way, the display 6 is supported by the panel 7.

In this embodiment, the panel 7 is a touch panel provided with a touch sensor. That is, the panel 7 is an example of a sensor portion (i.e., an operation portion, an input portion, or an input receiving portion). For example, the user can input information or perform operations using the surface of the panel 7.

In this embodiment, the panel 7 functions as both a protective panel and a touch panel, but the embodiments are not limited thereto. The panel 7 may function as any one of the protective panel and the touch panel. In addition, the panel 7 may not function as the protective panel and the touch panel, but may be provided for other purposes.

As illustrated in FIG. 3, the panel 7 has, for example, a rectangular plate shape. The panel 7 includes a front surface 7a (i.e., first surface), a rear surface 7b (i.e., a back surface or a second surface), and a side surface 7c (i.e., a circumferential surface or a third surface). The front surface 7a is exposed to the outside of the television 1. The rear surface 7b is opposite to the front surface 7a and extends substantially in parallel to the front surface 7a. The side surface 7c extends in a direction intersecting (e.g., substantially perpendicular to) the front surface 7a and the rear surface 7b. The side surface 7c connects the circumferential end (i.e., the end or the edge) of the front surface 7a and the circumferential end (i.e., the end or the edge) of the rear surface 7b.

The front surface 7a of the panel 7 forms a front surface of the display unit 5. The rear surface 6b of the display 6 forms a rear surface of the display unit 5. Each of the side surface 7c of the panel 7 and the side surface 6c of the display 6 forms a portion of a side surface (i.e., circumferential surface) of the display unit 5.

As illustrated in FIGS. 1 to 3, the housing 4 includes a front wall 11 (i.e., first wall), a rear wall 12 (i.e., a back wall or a second wall), and a sidewall 13 (i.e., a circumferential wall or a third wall). A portion of the front wall 11 is disposed in a front side on the front surface 6a of the display 6.

The front wall 11 includes a first opening 14 through which the panel 7 and the front surface 6a (e.g., display screen 8) of the display 6 are exposed. The front wall 11 has a frame shape covering the side surface 7c (i.e., circumferential surface) of the panel 7. In other words, the panel 7 is accommodated in the first opening 14 and is disposed inside the first opening 14. The front surface 7a of the panel 7 is substantially flush with, for example, the surface of the front wall 11 and is substantially connected to the surface of the front wall 11.

The rear wall 12 is opposite to the front wall 11. The rear wall 12 is disposed on the rear side of the display 6 and covers the rear surface 6b of the display 6. The rear wall 12 extends substantially in parallel to the front wall 11. The sidewall 13 extends in a direction intersecting (e.g., substantially perpendicular to) the front wall 11 and the rear wall 12. The sidewall 13 extends in the thickness direction of the housing 4. The sidewall 13 connects the front wall 11 (e.g., the circumferential end, end, or edge of the front wall 11) and the rear wall 12 (e.g., the circumferential end, end, or edge of the rear wall 12).

As illustrated in FIG. 3, the housing 4 includes a front mask 21 (i.e., a front cover, a first cover, or a first member) and a rear cover 22 (i.e., a base, a second cover, or a second member). Each of the front mask 21 and the rear cover 22 is an example of a housing member, a cover, a cover portion, a supporting portion, a protective portion, a wall, a component, or a member.

The front mask 21 includes the front wall 11 and the sidewall 13 and covers the side surface 6c of the display 6. The rear cover 22 includes the rear wall 12 and covers the rear surface 6b of the display 6. The rear cover 22 is coupled to the front mask 21. The rear cover 22 is attached to the front mask 21 to form an example of the housing 4.

Each of the front mask 21 and the rear cover 22 is an example of an external member (i.e., exterior member). Each of the front mask 21 and the rear cover 22 is exposed to the outside of the television 1 and forms a portion of the outer surface (i.e., an outward surface, a surface, or a surface exposed to the outside) of the television 1. The front mask 21 is attached to the stand 3 (i.e., external supporter) and is supported by the stand 3.

As illustrated in FIG. 3, the rear cover 22 according to this embodiment has a plate shape. The rear cover 22 includes a front surface 22a (i.e., an inner surface or a first surface), a rear surface 22b (i.e., a back surface, an outer surface, or a second surface), and a side surface 22c (i.e., a circumferential surface or a third surface). The front surface 22a is exposed to the inside of the housing 4 and faces the rear surface 6b of the display 6.

The rear surface 22b is opposite to the front surface 22a and is exposed to the outside of the housing 4. The rear surface 22b extends substantially in parallel to the front surface 22a. The side surface 22c extends in a direction intersecting (e.g., substantially perpendicular to) the front surface 22a and the rear surface 22b. The side surface 22c extends in the thickness direction of the housing 4. The side surface 22c connects the circumferential end (i.e., the end or the edge) of the front surface 22a and the circumferential end (i.e., the end or the edge) of the rear surface 22b.

As illustrated in FIG. 3, the sidewall 13 extends from the front wall 11 to the rear cover 22 (e.g., the circumferential end of the rear cover 22). The end of the sidewall 13 is disposed on the side of the rear cover 22 and faces the side surface 22c of the rear cover 22 (i.e., covers the side surface 22c). Therefore, when the housing 4 is viewed from the side, the rear cover 22 is not exposed to the outside. In this way, the housing 4 with a good outward appearance is provided.

As illustrated in FIG. 3, the front mask 21 includes a supporter 24 (i.e., a protruding portion, a protrusion, a holding portion, an attachment portion, a rib, an engaging portion, an annular portion, or a frame portion). The supporter 24 is a portion of the front mask 21 and is integrated with the front mask 21. The supporter 24 protrudes from the inner surface 13a of the sidewall 13 to the inside of the housing 4. The supporter 24 protrudes from the inner surface 13a of the sidewall 13 toward the side surface 6c of the display 6.

The supporter 24 protrudes from the inner surface 13a of the sidewall 13 in a direction substantially parallel to the rear surface 6b of the display 6 (i.e., a direction substantially perpendicular to the thickness direction of the housing 4). The supporter 24 is provided in an annular shape (i.e., frame shape) along the inner surface of the sidewall 13. The supporter 24 has an annular shape surrounding the side surface 6c (i.e., circumferential surface) of the display 6. The supporter 24 has an annular shape along the circumferential end of the display 6.

The supporter 24 continuously protrudes along the entire inner surface 13a (i.e., inner circumferential surface) of the sidewall 13. In this way, the supporter 24 defines a second opening 25 that surrounds the side surface 6c (i.e., circumferential surface) of the display 6. The second opening 25 is smaller than the first opening 14.

The supporter 24 is provided at a position that is away from the surface of the front wall 11 toward the rear side by, for example, a distance corresponding to or more than the thickness of the panel 7. The supporter 24 protrudes toward the inside (i.e., center) of the housing 4 in a direction substantially parallel to the rear surface 6b of the display 6 farther than the inner circumferential surface of the first opening 14 provided in the front wall 11. In this way, an attachment portion (i.e., an attachment surface, a mounting surface, or a mounting portion) to which the panel 7 can be attached is provided on the rear side of the first opening 14 by the supporter 24.

The supporter 24 faces the circumferential end of the rear surface 7b of the panel 7 and supports the circumferential end of the panel 7. The supporter 24 supports the panel 7, thereby supporting the display 6 via the panel 7. The adhesive portion (e.g., adhesive layer) is provided between the supporter 24 and the rear surface 7b of the panel 7. The adhesive portion is, for example, a double-sided tape. The supporter 24 may support at least one of the panel 7 and the display 6.

As illustrated in FIG. 3, the supporter 24 includes a first portion 24a (i.e., first region) and a second portion 24b (i.e., second region). The first portion 24a and the second portion 24b are aligned with and connected to each other in the thickness direction of the housing 4. The first portion 24a and the second portion 24b may be separated from each other.

The first portion 24a protrudes from the inner surface 13a of the sidewall 13 toward the side surface 6c of the display 6. The first portion 24a faces the side surface 6c of the display 6. In this embodiment, the first portion 24a supports the side surface 6c of the display 6.

The term “supporting the side surface of the display” is not limited to a case in which the first portion 24a constantly contacts and supports the side surface 6c of the display 6. The term “supporting the side surface of the display” includes a case in which there is a gap between the first portion 24a and the side surface 6c of the display 6 in a normal state and the first portion 24a comes into contact with the side surface 6c of the display 6 and supports the side surface 6c of the display 6, for example, during assembly or when external force is applied.

As illustrated in FIG. 3, the second portion 24b extends from the first portion 24a toward the rear cover 22. That is, the second portion 24b extends from the first portion 24a toward the rear side in the thickness direction of the housing 4.

The second portion 24b protrudes toward the rear side farther than the rear surface 6b of the display 6. That is, the second portion 24b protrudes toward the rear cover 22 farther than the rear surface 6b of the display 6. The second portion 24b is closer to the rear cover 22 than the rear surface 6b of the display 6. Each of the first portion 24a and the second portion 24b has an annular shape (i.e., frame shape) defining the second opening 25.

For example, when a driving board is provided and the rear surface 6b of the display 6 is uneven, the term “protruding toward the rear cover farther than the rear surface of the display” means protruding toward the rear cover 22 farther than the deepest portion (i.e., a portion closest to the front surface 6a of the display) of the rear surface 6b of the display 6.

Similarly, the term “portion closer to the rear cover than the rear surface of the display” means a portion closer to the rear cover 22 than the recess (i.e., the portion closest to the front surface 6a of the display) of the rear surface 6b of the display 6. In the specification, when the position of the rear surface 6b of the display 6 (or the display unit 5) is used as a reference position, the recess of the rear surface 6b of the display 6 (i.e., a portion closest to the front surface 6a of the display) is used as a reference portion.

The thickness T1 (e.g., the sum of the thickness of the first portion 24a and the thickness of the second portion 24b) of the supporter 24 is more than the thickness T2 of the display 6. In other words, the thickness T2 of the display 6 is less than the thickness T1 of the supporter 24. The display 6 is inserted (e.g., accommodated) into the second opening 25 and is disposed inside the second opening 25. The display 6 is within the thickness T1 of the supporter 24.

As illustrated in FIG. 3, the television 1 includes a first component 26 (i.e., a first electronic component or a first functional component), a second component 27 (i.e., a second electronic component or a second functional component), and a third component 28 (i.e., a third electronic component or a third functional component). Each of the first to third components 26, 27, and 28 is, for example, any one of a circuit board, a speaker, a microphone, and a connector, but is not limited thereto.

The first component 26 is provided between the display 6 and the rear cover 22. For example, the first component 26 is attached to the rear surface 6b of the display 6 along the second portion 24b of the supporter 24. The first component 26 faces the second portion 24b of the supporter 24. The first component 26 includes a surface 26a (i.e., a side surface, a supporting surface, or an attachment surface) that comes into contact with the second portion 24b of the supporter 24.

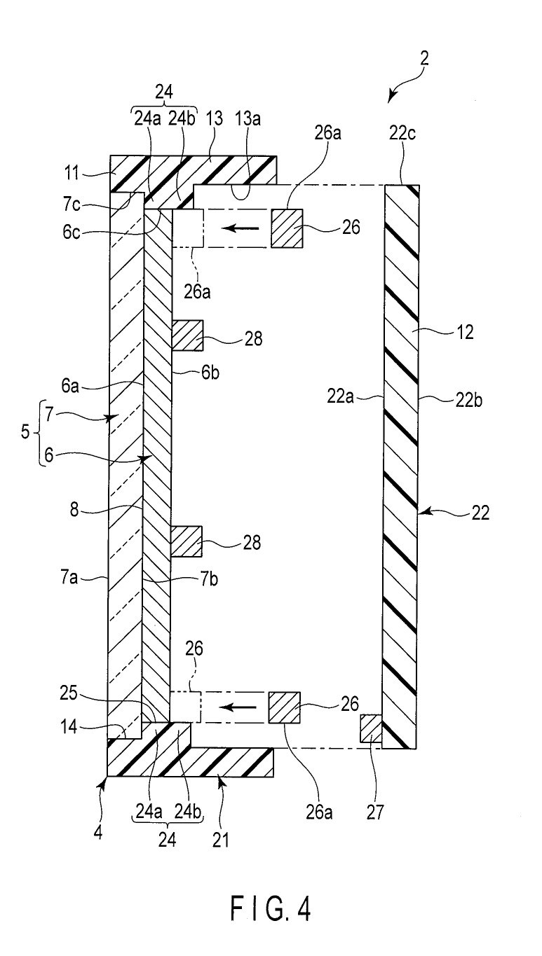

The position of the first component 26 is regulated from the side by the second portion 24b of the supporter 24. That is, the first component 26 is positioned by the second portion 24b of the supporter 24. As illustrated in FIG. 4, in the assembly of the television 1, the first component 26 is provided along (e.g., comes into contact with) the second portion 24b of the supporter 24. In this way, it is possible to position the first component 26 with ease.

As illustrated in FIG. 3, an accommodating portion 29 (i.e., an accommodating space or a space) in which the second component 27 is accommodated is provided between the supporter 24 and the rear cover 22. The second component 27 is attached to, for example, the rear cover 22 or the supporter 24 and is disposed between the supporter 24 and the rear cover 22.

The third component 28 is separated from, for example, the supporter 24 and is attached to the rear surface 6b of the display 6. At least a portion of each of the first component 26 and the third component 28 is inserted into the second opening 25 and is disposed inside the second opening 25.

According to this structure, it is possible to improve the heat dissipation performance and protect the display 6.

A plurality of heat generating portions (e.g., heat generating components) are provided in the housing 4. As the thickness of the television is reduced, a space for accommodating a heat dissipation structure including a fan is reduced or not existed in the television 1, which makes it difficult to dissipate heat in the housing 4. Therefore, it is necessary to improve the heat dissipation performance of the television 1.

In this embodiment, the supporter 24 of the front mask 21 includes the first portion 24a that faces the side surface of the display unit 5 and the second portion 24b that protrudes from the first portion 24a toward the rear cover 22 so as to be closer to the rear cover 22 than the rear surface of the display unit 5 and supports the display unit 5.

According to this structure, it is easy to form a gap (i.e., space) for the movement of air on the rear side of the display 6. Therefore, it is easy for heat to be moved in the housing 4 and it is easy for heat to be diffused in the housing 4. The heat diffused in the housing 4 is emitted to the outside of the housing 4 through the outer wall of the housing 4. In this way, it is possible to improve the heat dissipation performance of the television 1. When the supporter 24 is formed so as to be thicker than the display 6, it is possible to improve the solidity of the housing 4 around the display 6 and thus improve the protection of the display 6.

In this embodiment, the first component 26 is provided between the display 6 and the rear cover 22. The first component 26 is attached to the rear surface 6b of the display 6 along the second portion 24b of the supporter 24. That is, as illustrated in FIG. 4, the assembler can determine (i.e., locate) the mounting position of the first component 26 using the second portion 24b of the supporter 24. Therefore, it is possible to improve the assemblability of the television 1.

In this embodiment, the accommodating portion 29 capable of accommodating the second component 27 is provided between the supporter 24 and the rear cover 22. According to this structure, it is possible to mount components between the supporter 24 and the rear cover 22. Therefore, it is possible to achieve high-density mounting in the television 1 and reduce the thickness and size of the television 1.

In this embodiment, the third component 28 is provided between the display 6 and the rear cover 22. At least a portion of the third component 28 is disposed inside the second opening 25 which is defined by the annular supporter 24. That is, the third component 28 is provided in the housing 4 by the second opening 25. In this way, it is possible to achieve high-density mounting in the housing 4 and reduce the thickness and size of the housing 4.

### Second Embodiment

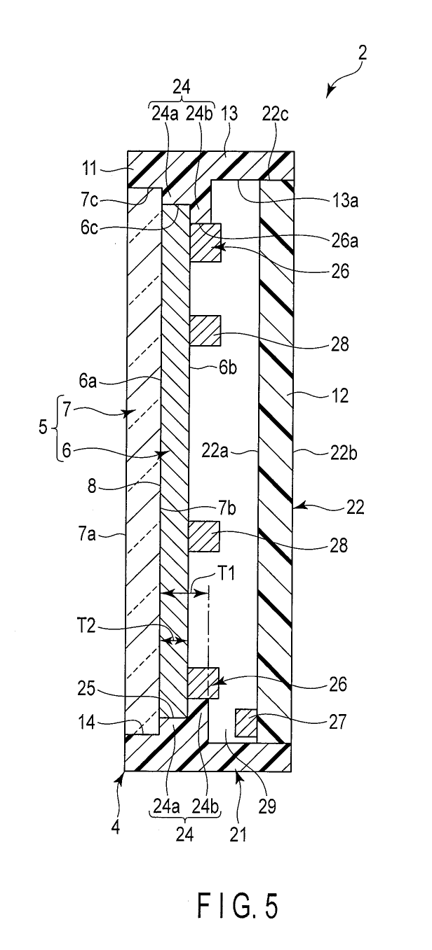

Next, a television 1 according to a second embodiment will be described with reference to FIG. 5. In the second embodiment, components having the same or similar functions as those in the first embodiment are denoted by the same reference numerals and the description thereof will not be repeated. Structures other than the following structures are the same as those in the first embodiment.

As illustrated in FIG. 5, in this embodiment, a part of a second portion 24b protrudes toward the inside (i.e., center) of a housing 4 in a direction substantially parallel to a rear surface 6b of the display 6 farther than a side surface 6c of a display 6. In this way, at least a part of the second portion 24b is disposed between the rear surface 6b of the display 6 and a rear cover 22.

The second portion 24b faces the rear surface 6b of the display 6 of the housing 4 and supports the rear surface 6b of the display 6. The term “supporting the rear surface of the display” is not limited to a case in which the supporter 24 constantly contacts and supports the rear surface 6b of the display 6. The term “supporting the rear surface of the display” includes a case in which there is a gap between the supporter 24 and the rear surface 6b of the display 6 in a normal state and the supporter 24 comes into contact with the rear surface 6b of the display 6 and supports the rear surface 6b of the display 6, for example, when the display is bent by external force.

According to this structure, the supporter 24 can support the rear surface 6b of the display 6, in addition to the same effect as that in the first embodiment. In this way, the supporter 24 can receive a portion of the pressing force applied to the display unit 5 when the user operates display unit 5. Therefore, it is possible to improve the protection of the display 6. In addition, it is possible to increase the size of the supporter 24 and thus improve the solidity of the housing 4.

### Third Embodiment

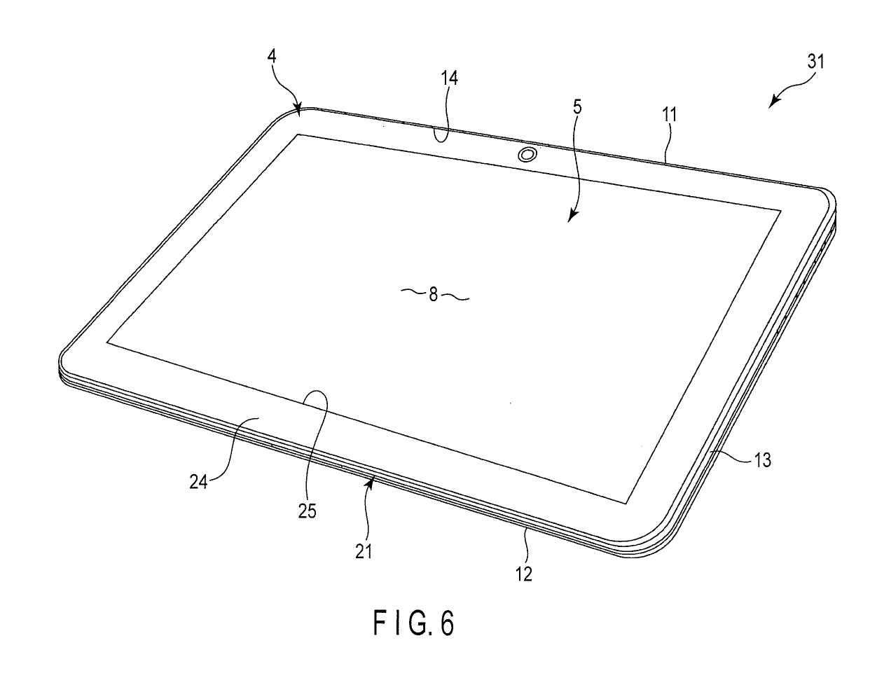

Next, an electronic apparatus 31 according to a third embodiment will be described with reference to FIGS. 6 to 9. In the third embodiment, components having the same or similar functions as those in the first and second embodiments are denoted by the same reference numerals and the description thereof will not be repeated. Structures other than the following structures are the same as those in the first embodiment. The term “television” in the first embodiment is replaced with an “electronic apparatus”.

As illustrated in FIG. 6, an electronic apparatus 31 according to this embodiment is, for example, a slate portable computer (i.e., a slate PC or a tablet). The electronic apparatus to which the structures according to all of the embodiments and modifications described in the specification can be applied is not limited to the above-mentioned example. All of the embodiments and modifications described in the specification can be widely applied to various electronic apparatuses, such as notebook portable computers (i.e., notebook PCs), televisions, mobile phones (including smart phones), and game machines.

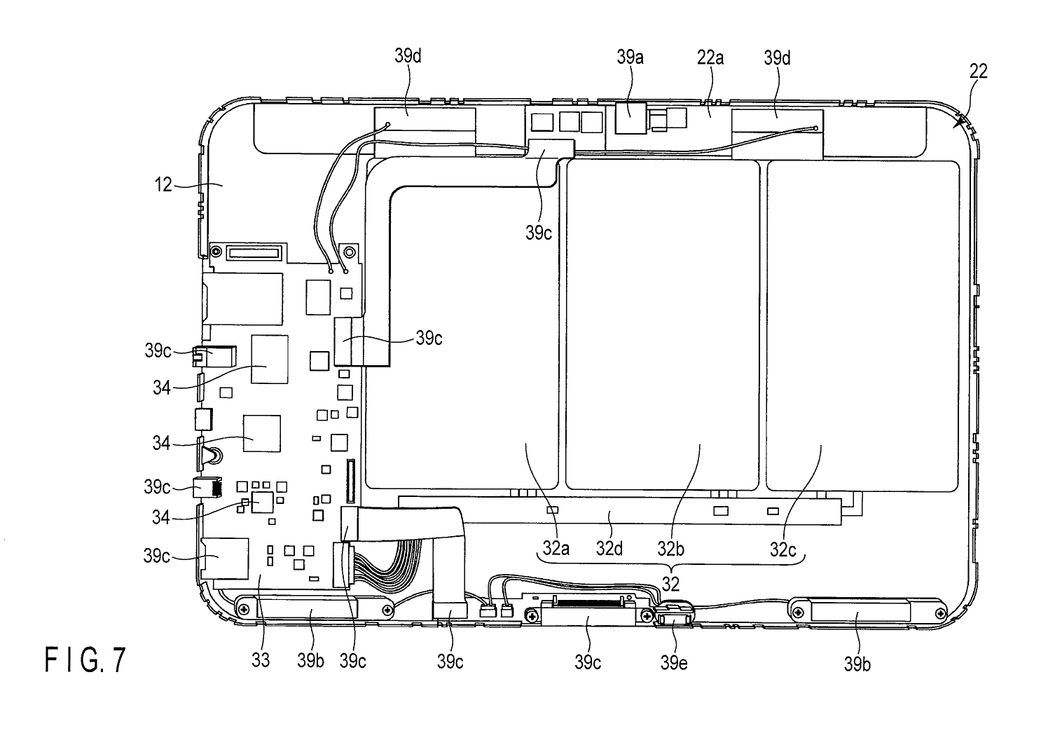

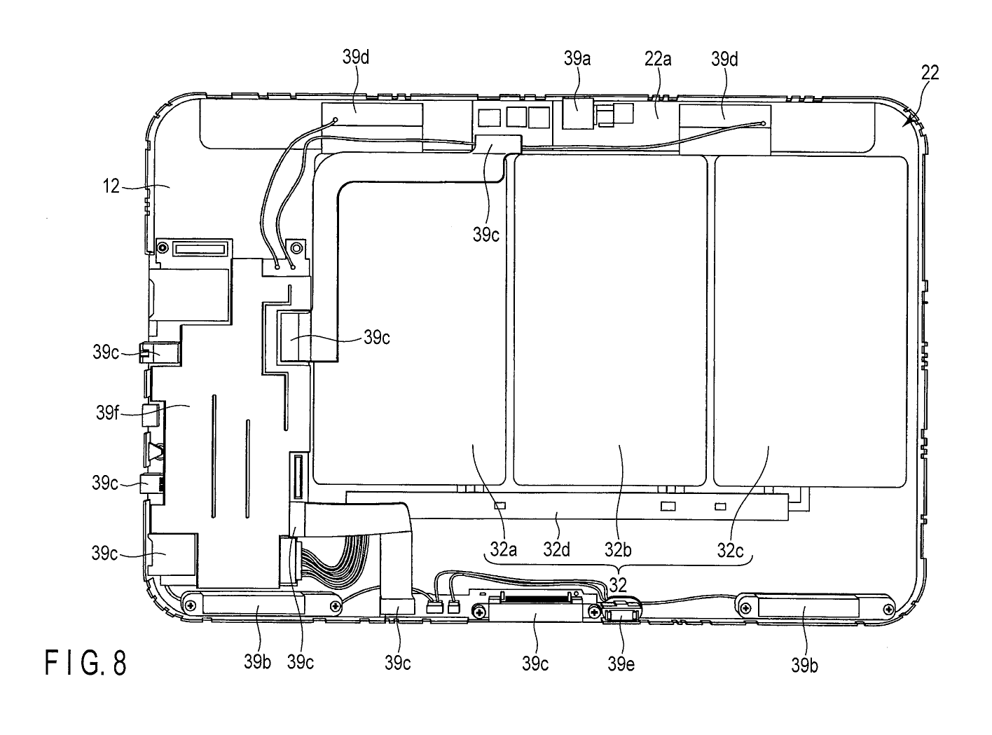

As illustrated in FIG. 6, the electronic apparatus 31 includes a housing 4 with a flat box shape. Similarly to the first embodiment, a display unit 5 is attached to (e.g., accommodated in) the housing 4. As illustrated in FIGS. 7 and 8, a battery 32 (e.g., cell) and a circuit board 33 (i.e., a printed circuit board, a control board, or a board) are accommodated in the housing 4.

As illustrated in FIG. 7, in this embodiment, the battery 32 includes a plurality of cells 32a, 32b, and 32c and a circuit board 32d. The cells 32a, 32b, and 32c are electrically connected in series or parallel to each other. The electrodes of the cells 32a, 32b, and 32c are electrically connected to the circuit board 32d. As such, since the cells 32a, 32b, and 32c are integrated with each other, the time and effort required for manufacture and manufacturing costs are reduced, as compared to a case in which the cells 32a, 32b, and 32c are independently assembled.

Each of the cells 32a, 32b, and 32c is an independent electric cell including a chamber (e.g., accommodating portion) in which, for example, an electrolyte (e.g., electrolytic solution), an electrode, and a separator are accommodated. Each of the cells 32a, 32b, and 32c has a rectangular parallelepiped shape (i.e., a plate shape, a square plate shape, or a card shape) which is thin and flat in the thickness direction of the housing 4.

In this embodiment, the outermost layer of each of the cells 32a, 32b, and 32c is a sheet-shaped sheath (i.e., a layer or a film) with an insulating property and flexibility and a hard case (i.e., shell) is not provided. According to this embodiment, it is possible to reduce the size (i.e., thickness) and weight of the battery 32 (i.e., cells 32a, 32b, and 32c) by a value corresponding to the portion in which the case is not provided. In this way, it is possible to reduce the size, thickness, and weight of the housing 4 (i.e., these of electronic apparatus 31).

A plurality of components 34 (i.e., components, elements, electronic components, or electric components) including, for example, a central processing unit (CPU) are provided on the circuit board 33. The components 34 include a heat-generating body. As illustrated in FIG. 7, the battery 32 and the circuit board 33 do not overlap each other in the thickness direction of the housing 4 and are arranged along a rear wall 12 of the housing 4. Therefore, it is possible to reduce the thickness of the housing 4, as compared to a case in which the battery 32 and the circuit board 33 overlap each other in the thickness direction of the housing 4.

As illustrated in FIG. 7, the housing 4 further includes a camera 39a (i.e., a camera module, a camera unit, a camera assembly, or an imaging device), a speaker 39b (i.e., a speaker module, a speaker unit, a speaker assembly, or a sound output device), a connector 39c (i.e., a connector module, a connector unit, a connector assembly, or a connector device), an antenna 39d (i.e., an antenna module, an antenna unit, an antenna assembly, or an antenna device), and a vibrator 39e (i.e., vibration generating portion). An example of the vibrator 39e is a motor in which an eccentric weight is attached to a rotating shaft.

As illustrated in FIG. 8, a heat dissipating portion 39f is attached to the circuit board 33. An example of the heat dissipating portion 39f is a plate made of a material (e.g., a metal material, such as an aluminum alloy) with high thermal conductivity. A thermally conductive sheet is provided between the heat dissipating portion 39f and the component 34. In this way, a portion of the heat generated from the component 34 is dissipated by the heat dissipating portion 39f.

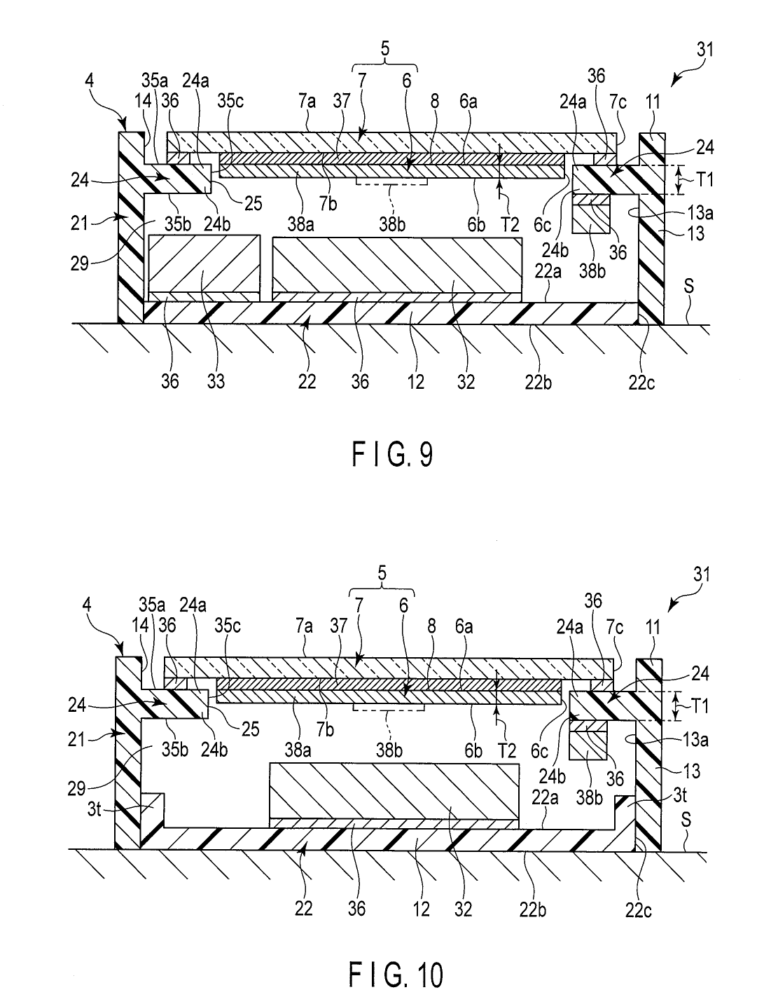

As illustrated in FIG. 9, in this embodiment, similarly to the first embodiment, the housing 4 includes a front mask 21 and a rear cover 22. The front mask 21 comes into contact with, for example, an external mounting surface S (i.e., a mounting surface or an installation surface) and is supported by the external mounting surface S. The external mounting surface S is an example of an “external supporter”.

As illustrated in FIG. 9, a supporter 24 includes a first surface 35a, a second surface 35b, and a third surface 35c. The first surface 35a and the second surface 35b are substantially parallel to a front surface 6a of a display 6. The first surface 35a faces the outside (e.g., front side) of the housing 4. The first surface 35a faces a rear surface 7b of the circumferential end of a panel 7.

The second surface 35b is opposite to the first surface 35a. The second surface 35b faces the inside of the housing 4. The second surface 35b faces the rear cover 22. The third surface 35c extends in a direction intersecting (e.g., substantially perpendicular to) the first surface 35a and the second surface 35b. The third surface 35c extends in the thickness direction of the housing 4. The third surface 35c extends between the first surface 35a and the second surface 35b. The third surface 35c faces a side surface 6c of the display 6. The third surface 35c defines a second opening 25.

In this embodiment, the panel 7 is fixed to the first surface 35a of the supporter 24. A first adhesive portion 36 (e.g., first adhesive layer) is provided between the panel 7 and the first surface 35a of the supporter 24. The first adhesive portion 36 is, for example, a double-sided tape. Similarly to the first embodiment, the display 6 is fixed to the rear surface 7b of the panel 7. A second adhesive portion 37 (e.g., second adhesive layer) is provided between the display 6 and the panel 7. The second adhesive portion 37 is, for example, a light-permeable double-sided tape (e.g., Optical Clear Adhesion (OCA)).

The thickness of each of the first and second adhesive portions 36 and 37 is, for example, about 0.15 mm. The first and second adhesive portions 36 and 37 have substantially the same thickness. In this way, the display 6 is disposed inside the second opening 25.

The display 6 according to this embodiment is, for example, a very thin sheet display. An example of the display 6 is a plastic organic EL display using a plastic board and has flexibility (i.e., bendability). For example, the thickness T2 of the display 6 is about 0.25 mm, but is not limited thereto.

The front mask 21 is made of, for example, a resin or metal. The front mask 21 made of a resin or metal is manufactured by, for example, injection molding, die-casting, or milling. In these manufacturing methods, there is a limitation in reducing the thickness T1 of the supporter 24 and it is difficult to reduce the thickness T1 of the supporter 24 to be less than about 0.4 mm. In addition, in order to ensure the strength of the supporter 24, the thickness of the supporter 24 needs to be equal to or more than a predetermined value.

Therefore, in this embodiment, the thickness T1 of the supporter 24 is more than the thickness T2 of the display 6. Therefore, similarly to the first embodiment, the supporter 24 includes a first portion 24a (i.e., first region) that faces the side surface 6c of the display 6 and a second portion 24b (i.e., second region) that is closer to the rear cover 22 than the rear surface 6b of the display 6.

That is, the first portion 24a protrudes from an inner surface 13a of a sidewall 13 toward the side surface 6c of the display 6. The first portion 24a faces the side surface 6c of the display 6. The second portion 24b protrudes from the first portion 24a toward the rear cover 22 so as to be closer to the rear cover 22 than the rear surface 6b of the display 6. The second portion 24b is closer to the rear cover 22 than the rear surface 6b of the display 6. The display 6 is inserted into (e.g., accommodated in) the second opening 25 and is disposed inside the second opening 25. The display 6 is within the thickness T1 of the supporter 24.

As illustrated in FIG. 9, the display 6 includes a display body 38a (i.e., a display body, a panel portion, or a sheet portion) including a display screen 8 and a circuit board 38b (i.e., a driving board, a control board, or a board) that drives the display body 38a. The display body 38a has a sheet shape and forms the front surface 6a, the rear surface 6c, and the side surface 6c of the display 6. In this embodiment, the circuit board 38b is separated from the display body 38a and is disposed between the supporter 24 and the rear cover 22. The circuit board 38b is attached to the second surface 35b of the supporter 24. The circuit board 38b is electrically connected to the display body 38a by, for example, a flexible wiring board.

The circuit board 38b may be attached to the first surface 35a or the third surface 35c of the supporter 24, or other positions. For example, the circuit board 38b may be attached to the sidewall 13 or the rear wall 12 of the housing 4, or various components or reinforcing members provided in the housing 4. The circuit board 38b may be integrated into the circuit board 33 (e.g., a main board or a main circuit board) provided in the housing 4.

In a modification of this embodiment, as represented by a two-dot chain line in FIG. 9, the circuit board 38b is attached to the rear surface of the display body 38a (e.g., the rear surface 6b of the display 6). At least a portion of the circuit board 38b is inserted into the second opening 25 and is disposed inside the second opening 25.

Next, an example of the connection structure (i.e., the engaging structure or the coupling structure) between the front mask 21 and the rear cover 22 according to this embodiment will be described with reference to FIGS. 10 to 17. The connection structure is not limited to this embodiment, but can be applied to all of the embodiments and modifications described in the specification.

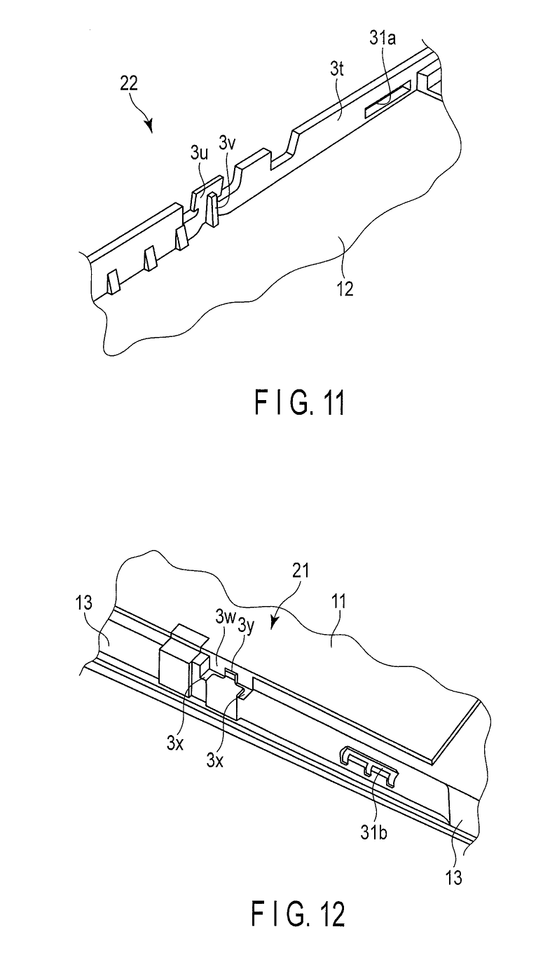

As illustrated in FIG. 10, the rear cover 22 includes a protruding portion 3t (i.e., protrusion). The protruding portion 3t protrudes from the rear wall 12 along the inner surface 13a of the sidewall 13. As illustrated in FIG. 11, an engaging portion 31a (i.e., first engaging portion) is provided in the protruding portion 3t. As illustrated in FIG. 12, an engaging portion 31b (i.e., second engaging portion) is provided in the sidewall 13 of the front mask 21. The engaging portion 31a and the engaging portion 31b are engaged with to each other in the thickness direction of the housing 4. In this embodiment, the engaging portion 31a is, for example, a through hole and the engaging portion 31b is, for example, a claw portion (a protruding portion or a protrusion). The engaging portion 31a and the engaging portion 31b are engaged with each other to couple the front mask 21 and the rear cover 22. As such, in this embodiment, for example, the front mask 21 and the rear cover 22 are coupled to each other by a relatively simple structure.

As illustrated in FIG. 11, the rear cover 22 includes a protruding portion 3u (i.e., first protruding portion). The protruding portion 3u protrudes from the rear wall 12 along the inner surface 13a of the sidewall 13. A rib 3v (i.e., protruding portion) is provided so as to protrude from the protruding portion 3u toward the inside of the housing.

As illustrated in FIG. 12, the front mask 21 includes a protruding portion 3w (i.e., a second protruding portion or a wall portion). The protruding portion 3w protrudes from the front wall 11 toward the rear wall 12 such that the protruding portion 3u is interposed between the protruding portion 3w and the sidewall 13 when assembly is completed. That is, the protruding portion 3w protrudes such that a gap (e.g., a gap that is slightly more than the thickness of the protruding portion 3u) capable of accommodating the protruding portion 3u is formed between the protruding portion 3w and the sidewall 13.

The front mask 21 includes two protruding portions 3x (i.e., third protruding portions or wall portions) which protrude from the front wall 11 toward the rear wall 12 so as to be engaged with the protruding portion 3u in a direction intersecting the thickness direction of the housing 4 (e.g., a direction along the sidewall 13). That is, the two protruding portions 3x protrude such that a gap (e.g., a gap that is slightly more than the width of the protruding portion 3u) capable of accommodating the protruding portion 3u is formed therebetween.

In this embodiment, for example, with the front mask 21 coupled to the rear cover 22, the protruding portion 3u is interposed between the sidewall 13 and the protruding portion 3w and is also interposed between the two protruding portions 3x in a direction different from the direction in which it is interposed between the sidewall 13 and the protruding portion 3w.

As illustrated in FIG. 12, the protruding portions 3w and 3x (i.e., wall portions) are connected to each other in a C-shape and are also connected to the sidewall 13. That is, an accommodating portion with a cylindrical shape (e.g., a square cylindrical shape or an annular shape) is formed by the sidewall 13 and the protruding portions 3w and 3x.

According to this structure, in this embodiment, for example, the movement of the protruding portion 3u of the rear cover 22 relative to the front mask 21 in the thickness direction of the sidewall 13 or the direction along the sidewall 13 is regulated. Therefore, according to this embodiment, for example, the separation between the contact edges of the front mask 21 and the rear cover 22 due to external force is prevented by a relatively simple structure. A cutout portion 3y (i.e., recess) in which the rib 3v is accommodated when assembly is completed is provided in the protruding portion 3w. Therefore, the edge of the cutout portion 3y in the protruding portion 3w also functions as a third protruding portion, similarly to the protruding portion 3x.

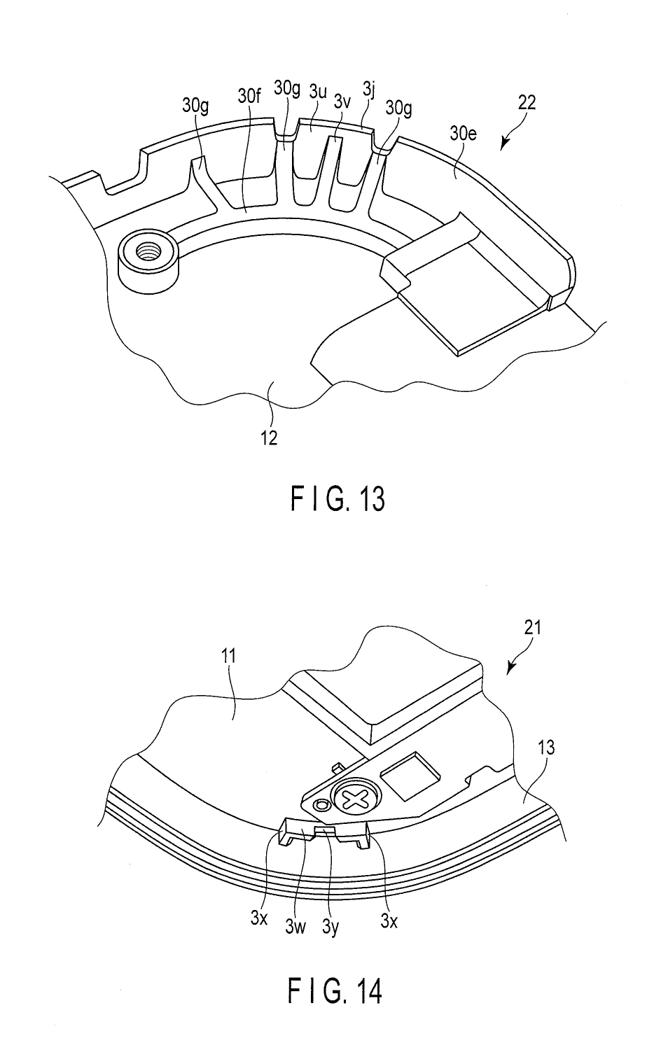

In this embodiment, for example, as illustrated in FIGS. 13 and 14, the protruding portion 3u (i.e., first protruding portion), the rib 3v, the protruding portion 3w (i.e., second protruding portion), and the protruding portion 3x (i.e., third protruding portion) are provided at four corners 3j of the housing 4. Therefore, according to this embodiment, for example, the front mask 21 and the rear cover 22 are less likely to be separated from each other at the corners 3j of the housing 4.

In this embodiment, for example, as illustrated in FIG. 13, the rear wall 12 includes a wall portion 30e that protrudes from the rear wall 12 toward the front wall 11. The protruding portion 3u is connected to the wall portion 30e while being curved in an arc shape along the edge of the corner 3j of the rear wall 12. Therefore, according to this embodiment, for example, it is possible to further improve the rigidity and strength of the protruding portion 3u. A protruding portion 30f which extends in an arc shape in parallel to the wall portion 30e and protrudes toward the front wall 11 is provided at a position where it is away from the wall portion 30e toward the center of the rear wall 12, that is, from the corner 3j or the end of the rear wall 12 to the center of the rear wall 12.

In addition, a protruding portion 30g (i.e., a rib or a second rib) is provided on the rear wall 12 so as to extend between the protruding portion 30f (i.e., a rib or a first rib) and the wall portion 30e. Therefore, according to this embodiment, for example, it is possible to further improve the rigidity and strength of the protruding portion 3u at the corner 3j to which external force is more likely to be applied than other portions when the electronic apparatus 31 drops.

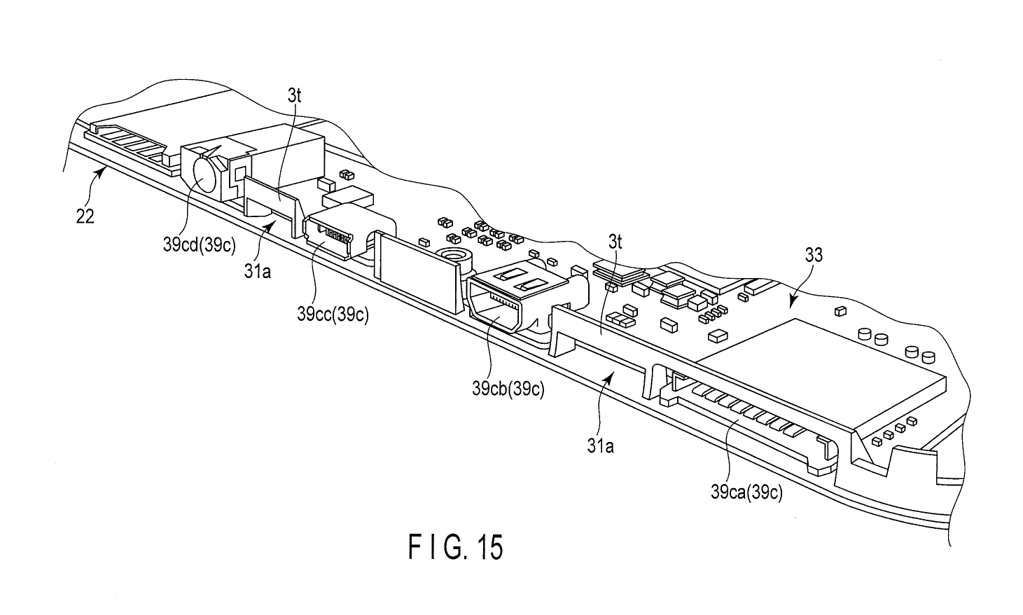

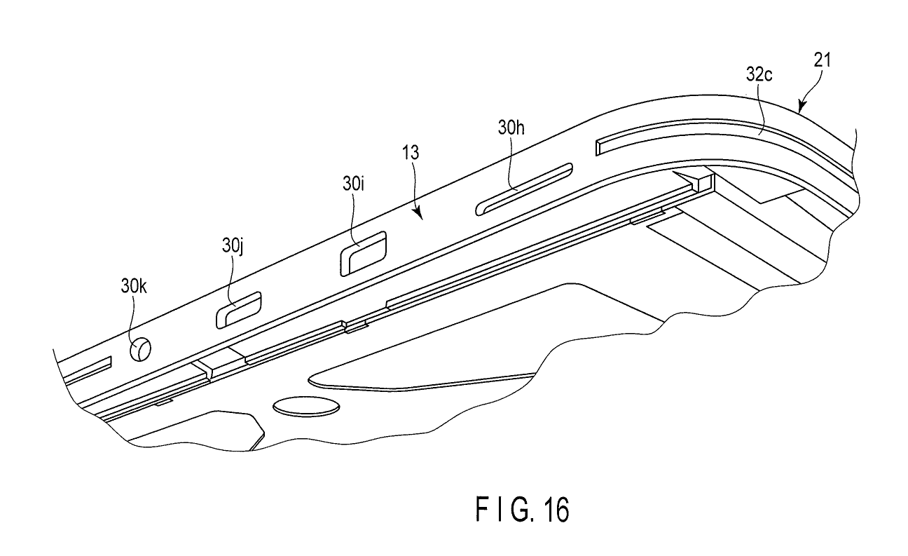

In this embodiment, for example, as illustrated in FIG. 15, connectors 39ca to 39cd are provided on the rear cover 21 so as to be arranged in a line along the edge of the rear cover 21. As illustrated in FIG. 16, openings 30h to 30k through which the connectors 39ca to 39cd are exposed to the outside of the housing 4 are provided as through holes in the sidewall 13. Therefore, according to this embodiment, the rigidity and strength of the sidewall 13 can be improved, as compared to, for example, a case in which cutout portions are provided as the openings 30h to 30k.

In FIG. 15, the connector 39ca is a connector for a card into which a card is removably inserted (i.e., connected or held). The connectors 39cb to 39cd are connectors into which other connectors are removably inserted (i.e., connected or held). The terminals (i.e., protrusions, supporters, leg portions, or protruding portions) of the connectors 39cb and 39 cc do not pass in the thickness direction of the board 33, but extend to the middle of the board 33 in the thickness direction.

Therefore, the terminals of the connectors 39cb and 39 cc do not hinder the adhesion (e.g., close adhesion) between the board 33 and the rear wall 12. When the height of (or the openings of) the connectors 39cb and 39 cc from the board 33 is appropriately set, the connectors 39cb and 39 cc and a member 32c which is provided at the intermediate position of the sidewall 13 can be arranged in a direction along the sidewall 13 (i.e., close to the sidewall 13).

Protruding portions 3t are provided between the connector 39ca and the connector 39cb and between the connector 39 cc and the connector 39cd. An engaging portion 31a is provided in the protruding portion 3t. The area of the engaging portion 31a serving as a through hole is gradually increased toward the opening side (i.e., the exit side or the opening end side). That is, in the engaging portion 31a, the distance from the center line of the through hole to a side surface (i.e., an inner surface, an inner circumferential surface, or a cylinder inner surface) is increased toward the exit-side end.

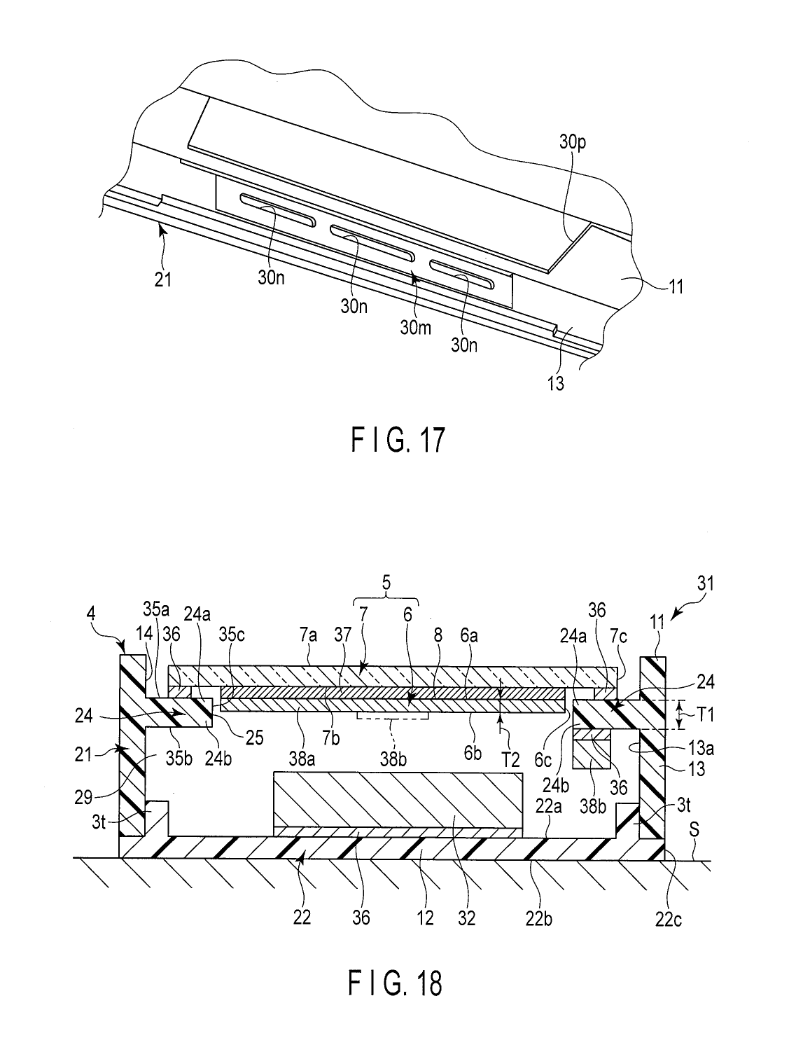

In this embodiment, for example, as illustrated in FIG. 17, a member 30m that extends along the end of the front mask 21 is provided on the sidewall 13 of the front mask 21. The member 30m is made of a material (e.g., a metal material) harder than that forming the front mask 21. Therefore, according to this embodiment, for example, it is possible to improve the rigidity and strength of the sidewall 13.

The member 30m illustrated in FIG. 17 faces the speaker module 39b and includes an opening 30n. The opening 30n makes it easy to output sounds from the speaker module 39b to the outside of the housing 4. That is, the member 30m is an example of a cover of the speaker module 39b. In addition, a cutout portion 30p in which the speaker module 39b is accommodated is provided in the front wall 11 of the front mask 21.

Therefore, according to this embodiment, for example, the member 30m can reinforce a portion which has lower rigidity or strength than a position without the cutout portion 30p due to the cutout portion 30p.

Next, a housing 4 according to a modification will be described with reference to FIG. 18. As illustrated in FIG. 18, in this modification, the front wall 11 of the front mask 21 protrudes with respect to the front surface 7a of the panel 7. In this case, the panel 7 or the display 6 can be protected by the protruding front wall 11. In both this modification and the above-described embodiment, as illustrated in FIG. 18, the side surface 22c of the rear cover 22 may not be covered with the front mask 21.

According to this structure, similarly to the first embodiment, it is possible to improve the heat dissipation performance and protect the display 6. Since the supporter 24 is thicker than the display 6, it is possible to improve the solidity of the housing 4 around the display 6.

In this embodiment, since the display 6 is thin and has flexibility, it is difficult to attach the circuit board 38b to the rear surface of the display body 38a. Therefore, when the circuit board 38b is separated from the display body 38a and is provided between the supporter 24 and the rear cover 22, the assemblability of the electronic apparatus 31 is improved.

### Fourth Embodiment

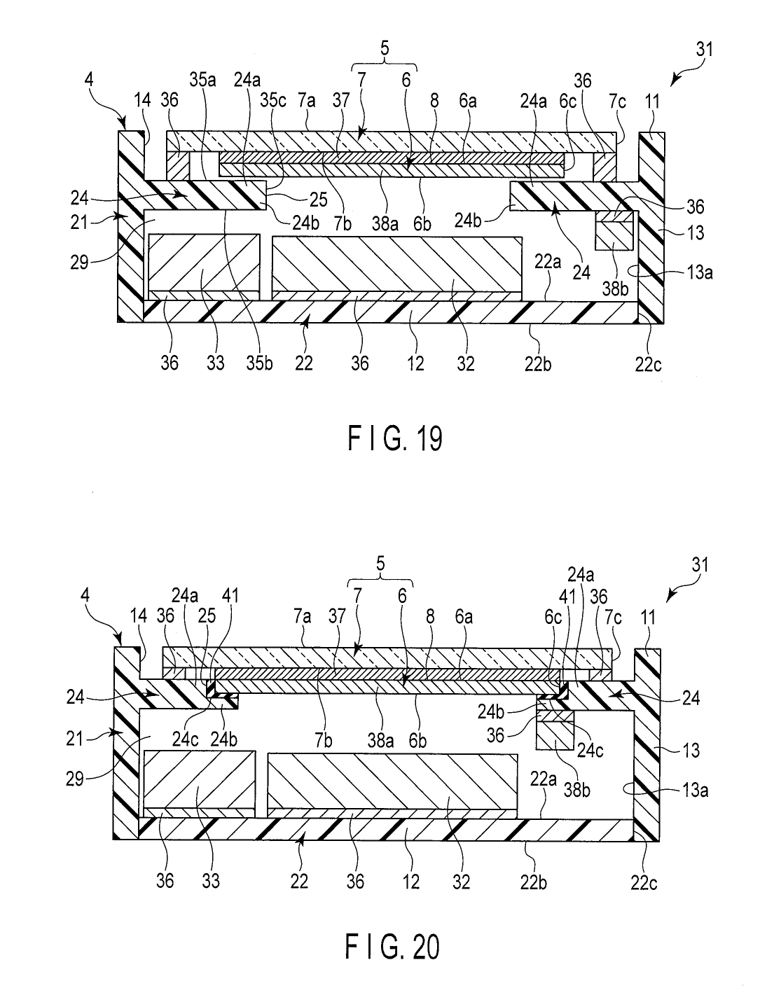

Next, an electronic apparatus 31 according to a fourth embodiment will be described with reference to FIG. 19. In the fourth embodiment, components having the same or similar functions as those in the first to third embodiments are denoted by the same reference numerals and the description thereof will not be repeated. Structures other than the following structures are the same as those in the third embodiment.

As illustrated in FIG. 19, in this embodiment, a display 6 is placed on a supporter 24. That is, the display 6 is disposed in front of the supporter 24. The supporter 24 is provided on the rear side of the display 6 and faces a rear surface 6b of the display 6.

Specifically, the supporter 24 is provided at a position that is away from the surface of a front wall 11 by a distance more than the sum of the thicknesses of the panel 7, a first adhesive portion 36, and the display 6. The supporter 24 protrudes from the inner surface of the sidewall 13 toward the inside of the housing 4 in a direction substantially parallel to the rear surface 6b of the display 6. The supporter 24 is disposed between the rear surface 6b of the display 6 and a rear cover 22. A first surface 35b of the supporter 24 faces the rear surface 6b of the display 6. In other words, the circumferential end of the display 6 is disposed between the panel 7 and the supporter 24.

In this embodiment, the supporter 24 supports the rear surface 6b of the display 6. The term “supporting the rear surface of the display” is not limited to a case in which the supporter 24 constantly contacts and supports the rear surface 6b of the display 6. The term “supporting the rear surface of the display” includes a case in which there is a gap between the supporter 24 and the display 6 in a normal state and the supporter 24 comes into contact with the display 6 and supports the display 6, for example, when the display is pressed and bent.

According to this structure, similarly to the first embodiment, it is possible to improve the heat dissipation performance and protect the display 6. In this embodiment, the supporter 24 faces the rear surface 6b of the display 6. According to this structure, the supporter 24 can support the rear surface 6b of the display 6 and it is possible to further improve the protection of the display 6. Even when a flexible display 6 is used, it is possible to prevent the bending of the display 6 and improve user convenience.

In this embodiment, the supporter 24 is disposed between the rear surface 6b of the display 6 and the rear cover 22. According to the supporter 24, it is possible to form the supporter 24 with a relatively large size, regardless of the size of the display 6. Therefore, the supporter 24 can relatively strongly support the display 6 and it is possible to improve the solidity of the housing 4. In this embodiment, it is possible to increase the size of the display 6, without being affected by the size of the supporter 24. Therefore, it is possible to provide an electronic apparatus 31 with a narrow frame.

### Fifth Embodiment

Next, an electronic apparatus 31 according to a fifth embodiment will be described with reference to FIG. 20. In the fifth embodiment, components having the same or similar functions as those in the first to fourth embodiments are denoted by the same reference numerals and the description thereof will not be repeated. Structures other than the following structures are the same as those in the third embodiment.

As illustrated in FIG. 20, in this embodiment, a supporter 24 includes a first portion 24a and a second portion 24b. The first portion 24a supports a rear surface 7b of a panel 7. In addition, the first portion 24a faces a side surface 6c of a display 6. The second portion 24b is provided on the rear side (e.g., lower side) of the first portion 24a and protrudes from the first portion 24a toward the inside (i.e., center) of a housing 4. The second portion 24b is disposed between a rear surface 6b of the display 6 and a rear cover 22 and faces the rear surface 6b of the display 6.

A step portion 24c is provided between the first portion 24a and the second portion 24b. The rear surface 6b of the display 6 faces the step portion 24c. An elastic member 41 (i.e., an elastic portion, a buffer portion, or a buffer member) is provided between the display 6 and the step portion 24c. The elastic member 41 includes a first portion that is disposed between the side surface 6c of the display 6 and the supporter 24 and a second portion that is disposed between the rear surface 6b of the display 6 and the supporter 24. The elastic member 41 is rubber or elastomer, such as a thermoplastic polyurethane resin (TPU).

According to this structure, similarly to the first embodiment, it is possible to improve the heat dissipation performance and protect the display 6. In this embodiment, the supporter 24 faces the rear surface 6b of the display 6. According to this structure, the supporter 24 and the elastic member 41 can support the rear surface 6b of the display 6 and it is possible to further improve the protection of the display 6 and prevent the bending of the display 6.

In this embodiment, the elastic member 41 is provided between the supporter 24 and the display 6. The elastic member 41 can absorb a portion of the pressing force from the user. Therefore, it is possible to further improve the protection of the display 6 and prevent the bending of the display 6.

### Sixth Embodiment

Next, an electronic apparatus 31 according to a sixth embodiment will be described with reference to FIG. 21. In the sixth embodiment, components having the same or similar functions as those in the first to fifth embodiments are denoted by the same reference numerals and the description thereof will not be repeated. Structures other than the following structures are the same as those in the third embodiment.

As illustrated in FIG. 21, a battery 32 (i.e., a component, a member, or a functional component) according to this embodiment includes a battery case 42 (i.e., a case, an exterior member, a protective portion, a protective member, a supporting member, a battery chassis, a member, or a component) having a cell 32a accommodated therein. The battery case 42 has relatively high strength. The battery 32 is provided between a display 6 and a rear cover 22. In this embodiment, at least a portion of the battery case 42 is inserted into a second opening 25.

As illustrated in FIG. 21, at least a portion of the battery case 42 is disposed inside the second opening 25 and faces a rear surface 6b of the display 6. The battery case 42 supports the rear surface 6b of the display 6. The battery case 42 is an example of a “supporter (i.e., a supporting member, a reinforcing portion, or a reinforcing member)” that is disposed inside the second opening 25 and supports the display 6.

The term “supporting the rear surface of the display” is not limited to a case in which the battery case 42 constantly contacts and supports the rear surface 6b of the display 6. The term “supporting the rear surface of the display” includes a case in which there is a gap between the battery case 42 and the display 6 in a normal state and the battery case 42 comes into contact with the display 6 and supports the display 6, for example, when the display 6 is pressed and bent. In this embodiment, an insulator 43 (i.e., insulating portion) is provided between the battery case 42 and the display 6.

In this embodiment, the battery case 42 includes, for example, a first portion 42a that covers the cell 32a and a second portion 42b that extends from the first portion 42a. The first portion 42a is provided between the cell 32a and the display 6. The second portion 42b is an extended portion (e.g., rib) that extends from the first portion 42a toward the sidewall 13 of the housing 4. For example, the second portion 42b is disposed between another component 27 (e.g., a circuit board 33) and the display 6. In this embodiment, a part of each of the first portion 42a and the second portion 42b is disposed inside the second opening 25. One of the first portion 42a and the second portion 42b may not be provided.

According to this structure, the battery case 42 (i.e., supporter) can support the rear surface 6b of the display 6. Therefore, it is possible to protect the display 6, prevent the bending of the display 6, and improve the solidity of the housing 4. When an extended portion (i.e., second portion 42b) is provided in the battery case 42, it is possible to support the large area of the display 6. Therefore, it is possible to further improve the protection of the display 6 and the solidity of the housing 4 and prevent the bending of the display 6.

### Seventh Embodiment

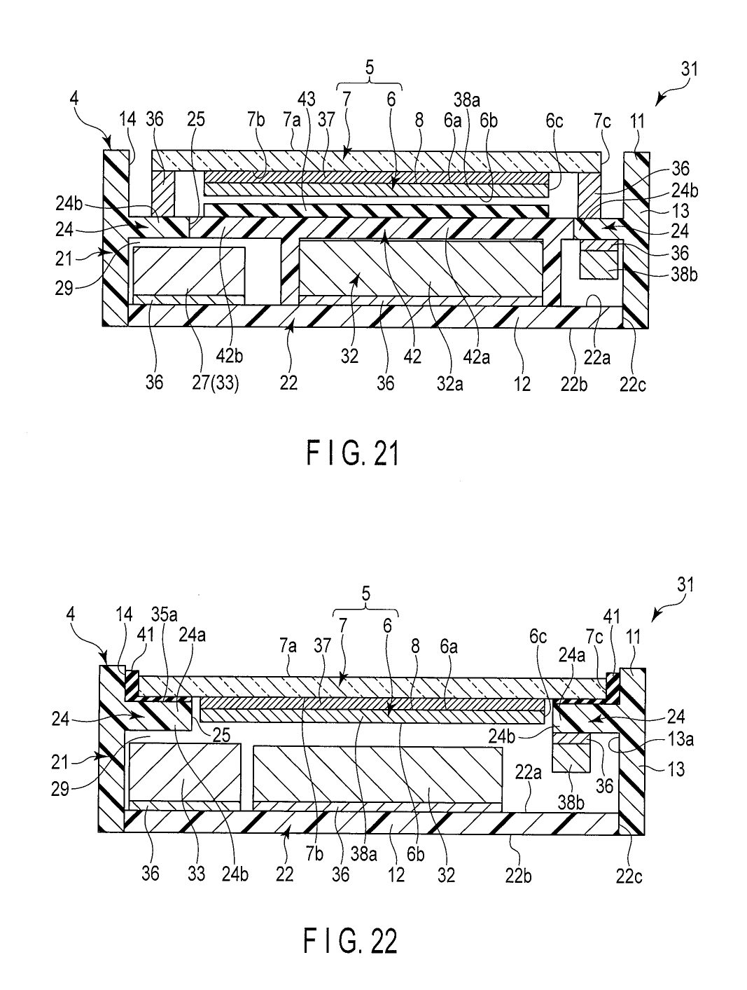

Next, an electronic apparatus 31 according to a seventh embodiment will be described with reference to FIG. 22. In the seventh embodiment, components having the same or similar functions as those in the first to sixth embodiments are denoted by the same reference numerals and the description thereof will not be repeated. Structures other than the following structures are the same as those in the third embodiment.

As illustrated in FIG. 22, in this embodiment, an elastic member 41 (i.e., an elastic portion, a buffer portion, or a buffer member) is provided between the circumferential end of a panel 7 and a supporter 24. The elastic member 41 includes a first portion that is provided between an inner surface 13a of a sidewall 13 and a side surface 7c of a panel 7 and a second portion that is provided between a first surface 35a of the supporter 24 and a rear surface 7b of the panel 7.

According to this structure, similarly to the first embodiment, it is possible to improve the heat dissipation performance and protect a display 6. In addition, in this embodiment, the elastic member 41 can support the rear surface 7b of the panel 7 and it is possible to protect the display 6 and suppress the bending of the display 6.

### Eighth Embodiment

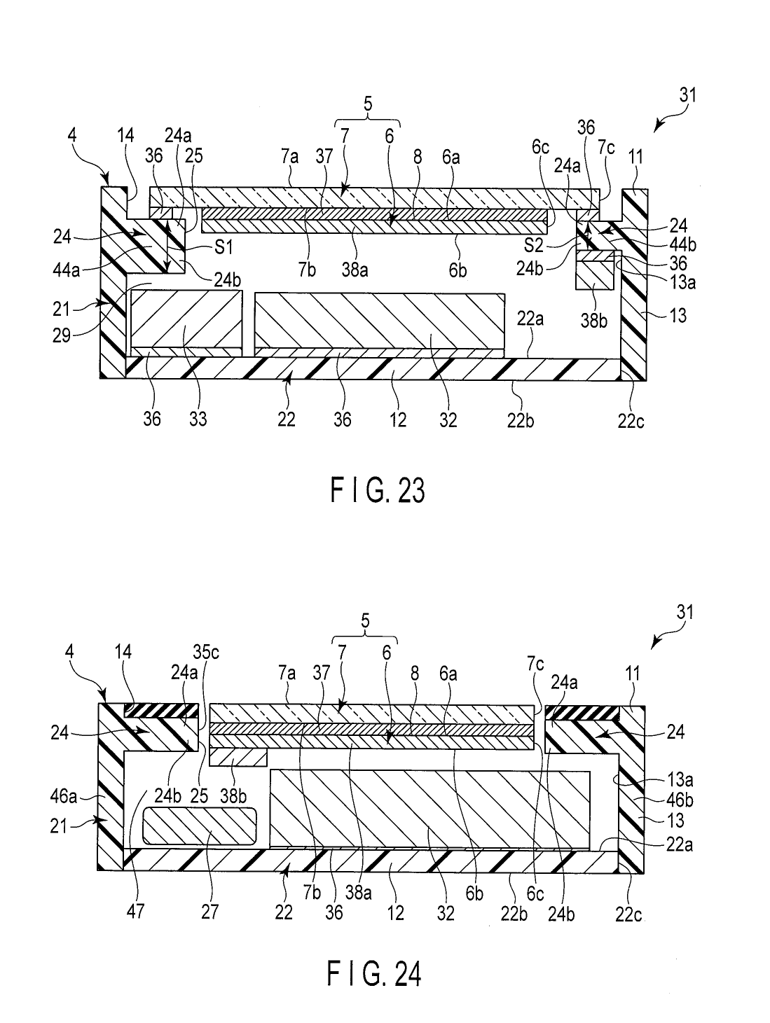

Next, an electronic apparatus 31 according to an eighth embodiment will be described with reference to FIG. 23. In the eighth embodiment, components having the same or similar functions as those in the first to seventh embodiments are denoted by the same reference numerals and the description thereof will not be repeated. Structures other than the following structures are the same as those in the third embodiment.

As illustrated in FIG. 23, a supporter 24 according to this embodiment is provided in an annular shape (i.e., frame shape) and has a non-uniform thickness. That is, the supporter 24 includes a first portion 44a (i.e., first region) with a first thickness S1 and a second portion 44b (i.e., second region) with a second thickness S2 less than the first thickness. A circuit board 38b or other components are attached to the second portion 44b.

According to this structure, similarly to the first embodiment, it is possible to improve the heat dissipation performance and protect the display 6. In this embodiment, a part of the supporter 24 is thin and a component is attached to the thin region. In this way, it is possible to reduce the thickness of a housing 4 (i.e., the thickness of an electronic apparatus 31). The supporter 24 may be formed so as to be partially thick, thereby improving the strength of a necessary portion of the housing 4. This contributes to improving the solidity of the housing 4.

### Ninth Embodiment

Next, an electronic apparatus 31 according to a ninth embodiment will be described with reference to FIG. 24. In the ninth embodiment, components having the same or similar functions as those in the first to eighth embodiments are denoted by the same reference numerals and the description thereof will not be repeated. Structures other than the following structures are the same as those in the third embodiment.

As illustrated in FIG. 24, in this embodiment, a battery 32 (i.e., a functional component, a component, or a member) is provided so as to deviate from a display 6. That is, the center of the battery 32 does not overlap the center of the display 6 in the thickness direction of a housing 4. The center of the display 6 is substantially aligned with the center of the housing 4.

A sidewall 13 of the housing 4 includes a first sidewall portion 46a (i.e., first portion) and a second sidewall portion 46b (i.e., second portion). The second sidewall portion 46b is opposite to the first sidewall portion 46a. The battery 32 is provided between the first sidewall portion 46a and the second sidewall portion 46b. The battery 32 is closer to the second sidewall portion 46b than to the first sidewall portion 46a. In this way, an accommodating region 47 (i.e., an accommodating portion, an accommodating space, space, or a region) is provided between the first sidewall portion 46a and the battery 32. For example, a component 27 is provided in the accommodating region 47.

According to this structure, similarly to the first embodiment, it is possible to improve the heat dissipation performance and protect the display 6. In this embodiment, since the battery 32 is provided so as to deviate from the display 6, a mounting area is ensured in the housing 4. In this way, it is possible to provide an electronic apparatus 31 in which components can be mounted with high density.

### Tenth Embodiment

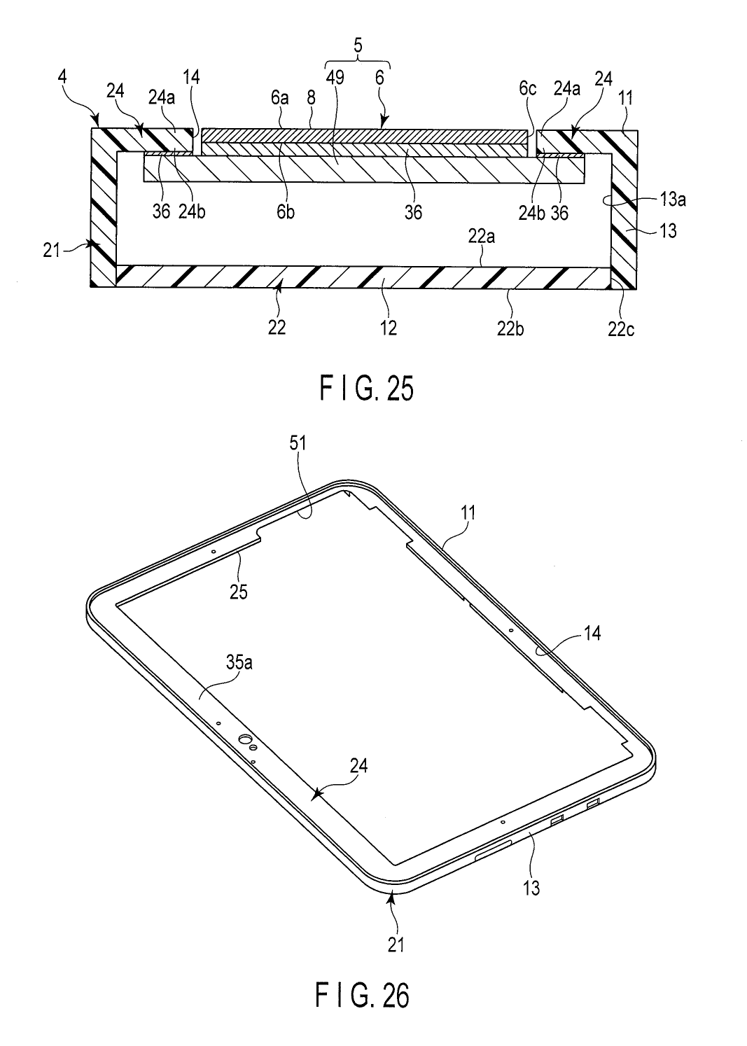

Next, an electronic apparatus 31 according to a tenth embodiment will be described with reference to FIG. 25. In the tenth embodiment, components having the same or similar functions as those in the first to ninth embodiments are denoted by the same reference numerals and the description thereof will not be repeated. Structures other than the following structures are the same as those in the third embodiment.

In this embodiment, an opening 14 is provided in a front wall 11 of a housing 4. A display 6 is disposed inside the opening 14 and is exposed to the outside of the housing 4. A touch sensor 49 (i.e., touch panel) is attached to the inner surface of the front wall 11 and faces a rear surface 6b of the display 6. The display 6 is attached to a touch sensor 49 by an adhesive portion 36. In this embodiment, the adhesive portion 36 may not be light-permeable. The touch sensor 49 is supported by the housing 4 and supports the display 6.

According to this structure, the touch sensor 49 can support the rear surface 6b of the display 6 and it is possible to protect the display 6. In addition, according to this embodiment, since the display 6 is close to the user, the visibility of the screen is improved. That is, since a panel 7 is not provided in front of the display 6, interface reflection is reduced and the brightness of the screen is improved. In addition, there is no concern that air bubbles will be inserted between the front surface 6a of the display 6 and the panel 7 and it is possible to improve product yield.

### Eleventh Embodiment

Next, an electronic apparatus 31 according to an eleventh embodiment will be described with reference to FIGS. 26 to 29. In the eleventh embodiment, components having the same or similar functions as those in the first to tenth embodiments are denoted by the same reference numerals and the description thereof will not be repeated. Structures other than the following structures are the same as those in the third embodiment.

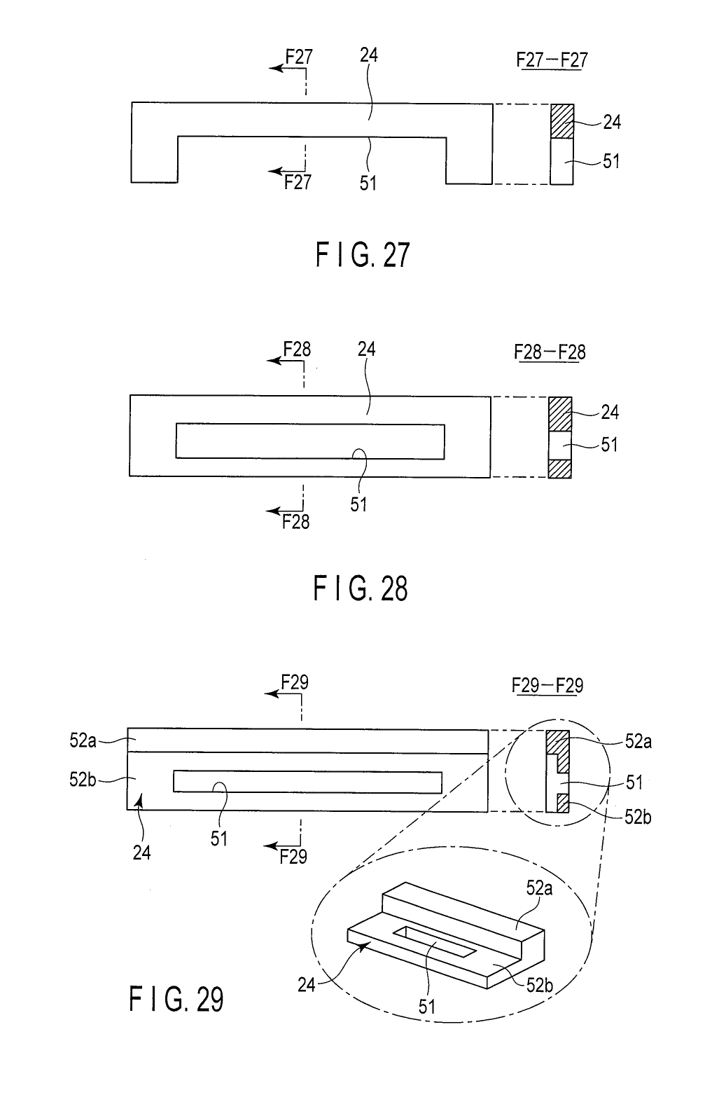

As illustrated in FIG. 26, for example, a drawing portion 51 for a flexible wiring board connected to a panel 7 is provided in a supporter 24 according to this embodiment. As illustrated in FIG. 27, an example of the drawing portion 51 is a cutout portion provided in the supporter 24. FIG. 28 shows a first modification of the drawing portion 51. As illustrated in FIG. 28, the drawing portion 51 may be an opening (i.e., a through hole or a hole) that is provided in the supporter 24.

FIG. 29 shows a second modification of the drawing portion 51. As illustrated in FIG. 29, the supporter 24 includes a first portion 52a and a second portion 52b that is thinner than the first portion 52a. The drawing portion 51 may be an opening (i.e., a through hole or a hole) that is provided in the second portion 52b. At least a portion of the flexible wiring board is disposed within the range of the thickness difference between the first portion 52a and the second portion 52b. That is, a step is formed between the first portion 52a and the second portion 52b to compensate for the thickness of the flexible wiring board.

According to this structure, similarly to the first embodiment, it is possible to improve the heat dissipation performance and protect the display 6. In this embodiment, the shape of the drawing portion 51 enables the supporter 24 to have rigidity. For example, when a cutout portion or an opening is provided in a portion through which the flexible wiring board passes, it is possible to further extend the supporter 24 to the inside (i.e., center) of the housing 4. In this way, it is possible to increase the solidity of the housing 4.

### Twelfth Embodiment

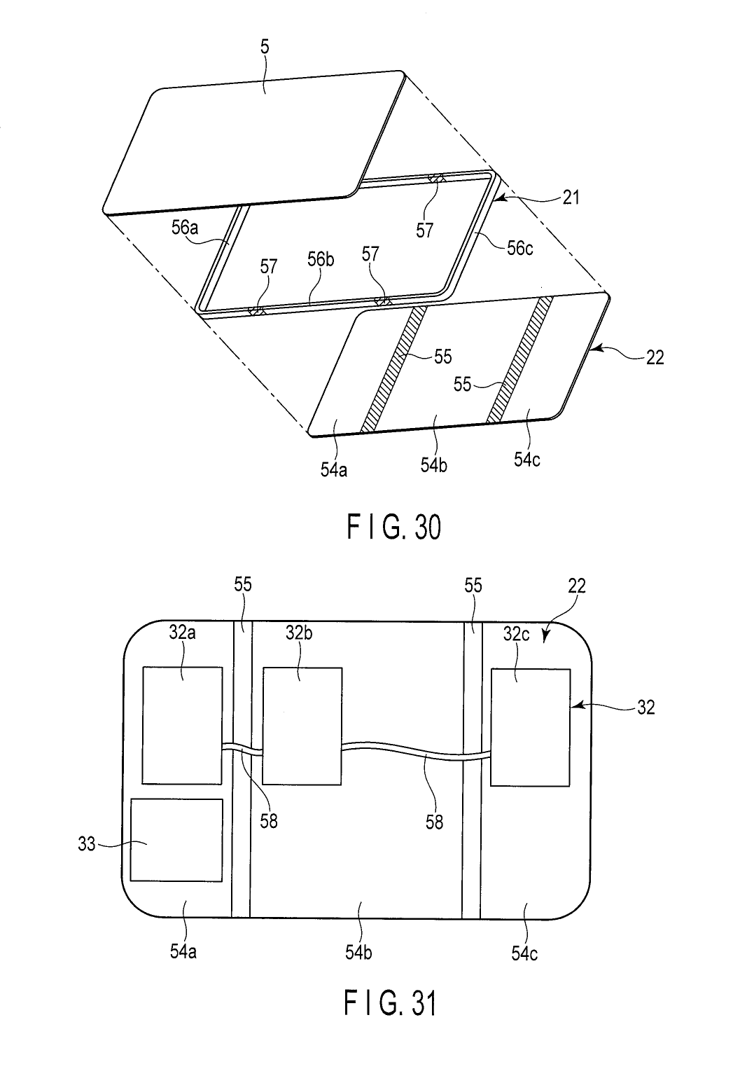

Next, an electronic apparatus 31 according to a twelfth embodiment will be described with reference to FIGS. 30 and 31. In the twelfth embodiment, components having the same or similar functions as those in the first to eleventh embodiments are denoted by the same reference numerals and the description thereof will not be repeated. Structures other than the following structures are the same as those in the third embodiment.

As illustrated in FIG. 30, a rear cover 22 includes a first region 54a (i.e., a first portion or a first member), a second region 54b (i.e., a second portion or a second member), and a third region 54c (i.e., a third portion or a third member). The first to third regions 54a, 54b, and 54c are made of plastic or metal and have rigidity.

First elastic portions 55 (i.e., bent portions, flexible portions, or bendable portions) are provided between the first to third regions 54a, 54b, and 54c. The first elastic portion 55 is, for example, rubber or elastomer. In this way, the first to third regions 54a, 54b, and 54c can be bent with respect to each other.

A front mask 21 includes a first region 56a (i.e., a first portion or a first member), a second region 56b (i.e., a second portion or a second member), and a third region 56c (i.e., a third portion or a third member) so as to correspond to the rear cover 22. The first to third regions 56a, 56b, and 56c are made of plastic or metal and have rigidity.

Second elastic portions 57 (i.e., bent portions, flexible portions, or bendable portions) are provided between the first to third regions 56a, 56b, and 56c. The second elastic portions 57 are provided at positions corresponding to the first elastic portions 55. The second elastic portion 57 is, for example, rubber or elastomer. In this way, the first to third regions 56a, 56b, and 56c can be bent with respect to each other.

The panel 7 is made of an elastic member (i.e., a flexible member or a bendable member) such as plastic. The display 6 is a flexible sheet display. That is, a display unit 5 has flexibility. A housing 4 (i.e., electronic apparatus 31) can be bent or deformed around the first elastic portion 55 and the second elastic portion 57.

As illustrated in FIG. 31, a circuit board 33 and a battery 32 are provided in the housing 4. The circuit board 33 is attached to the first region 54a of the rear cover 22. The battery 32 includes a first cell 32a, a second cell 32b, and a third cell 32c. The first cell 32a is attached to the first region 54a of the rear cover 22. The second cell 32b is attached to the second region 54b of the rear cover 22. The third cell 32c is attached to the third region 54c of the rear cover 22.

That is, none of the circuit board 33 and the cells 32a, 32b, and 32c are provided across the regions 54a, 54b, and 54c of the rear cover 22. The cells 54a, 54b, and 54c are electrically connected to each other by a cable 58 or a flexible wiring board.

According to this structure, it is possible to provide a bendable electronic apparatus 31. In this embodiment, the elastic portions 55 are provided between the regions (e.g., members) 54a, 54b, and 54c of the rear cover 22 and bendable portions are provided. On the other hand, the circuit board 33 and the cells 32a, 32b, and 32c are separately arranged in the first to third regions 54a, 54b, and 54c which are less likely to be bent. In this way, it is possible to protect the circuit board 33 or the cells 32a, 32b, and 32c.

### Thirteenth Embodiment

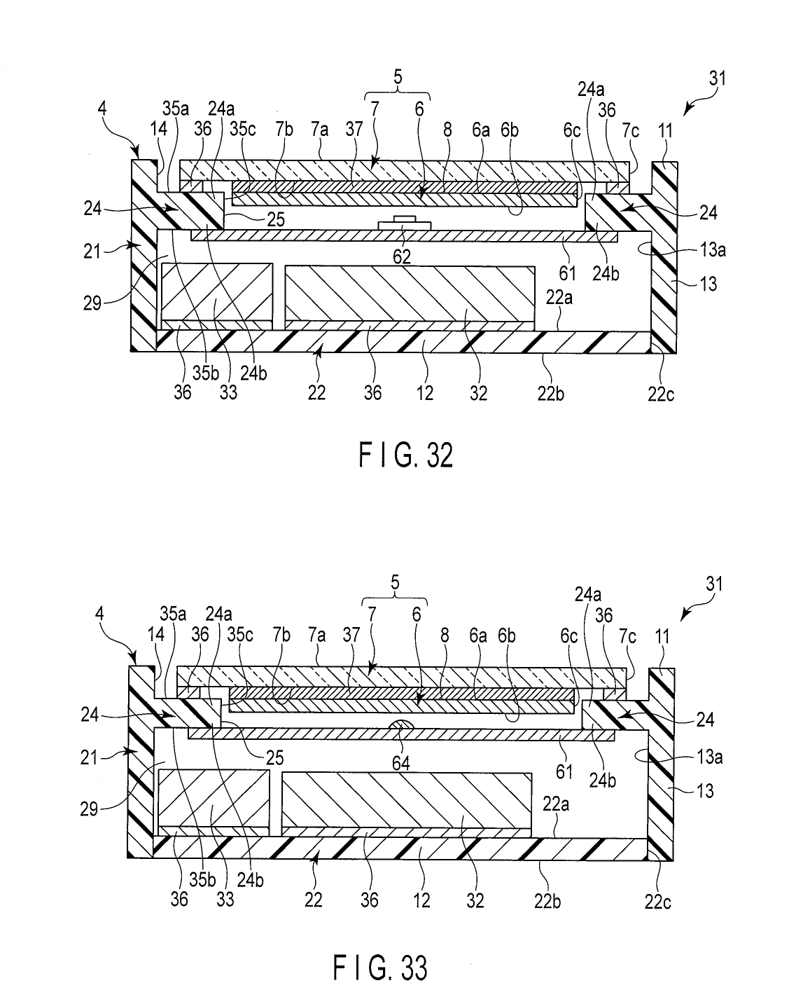

Next, an electronic apparatus 31 according to a thirteenth embodiment will be described with reference to FIG. 32. In the thirteenth embodiment, components having the same or similar functions as those in the first to twelfth embodiments are denoted by the same reference numerals and the description thereof will not be repeated. Structures other than the following structures are the same as those in the third embodiment.

As illustrated in FIG. 32, this embodiment includes a supporting member 61 that is provided in a housing 4 and a switch 62 that is supported by the supporting member 61. The switch 62 is an example of a component (i.e., an electronic component or a functional component). At least a portion of the switch 62 is inserted into a second opening 25 and is disposed inside the second opening 25. The switch 62 faces a rear surface 6b of a display 6.

In this embodiment, the display unit 5 is flexible (i.e., bendable). The housing 4 may be made of, for example, plastic and may have flexibility (i.e., bendability). When a panel 7 (i.e., display 6) is pressed, the panel 7 and the display 6 are deformed (i.e., bent) and the rear surface 6b of the display 6 comes into contact with the switch 62. The switch 62 is operated by the rear surface 6b of the display 6. An image indicating the switch 62 may be displayed on a display screen 8 of the display 6 at a position corresponding to the switch 62.

According to this structure, similarly to the first embodiment, it is possible to improve the heat dissipation performance and protect the display 6. In this embodiment, the second opening 25 is used to arrange the switch 62. Therefore, it is possible to improve user convenience, achieve high-density mounting in the electronic apparatus 31, and reduce the thickness and size of the electronic apparatus 31.

### Fourteenth Embodiment

Next, an electronic apparatus 31 according to a fourteenth embodiment will be described with reference to FIG. 33. In the fourteenth embodiment, components having the same or similar functions as those in the first to thirteenth embodiments are denoted by the same reference numerals and the description thereof will not be repeated. Structures other than the following structures are the same as those in the third embodiment.

In this embodiment, a display unit 5 is flexible (i.e., bendable). A housing 4 may be made of, for example, plastic and may have flexibility (i.e., bendability). As illustrated in FIG. 33, this embodiment includes a supporting member 61 that is provided in the housing 4 and a stopper 64 (i.e., bending regulating portion) that is supported by the supporting member 61. The stopper 64 is an example of a component (i.e., an electronic component or a functional component). At least a portion of the stopper 64 is inserted into a second opening 25 and is disposed inside the second opening 25. The stopper 64 faces a rear surface 6b of a display 6.

When a panel 7 (i.e., display 6) is pressed, the panel 7 and the display 6 are deformed (i.e., bent). When the bending angle of the display 6 is greater than a predetermined value, the height or position of the stopper 64 is adjusted such that the rear surface 6b of the display 6 comes into contact with the stopper 64.

In this way, when the bending angle of the display 6 is greater than the predetermined value, the stopper 64 supports the rear surface 6b of the display 6 to prevent the display 6 from being bent any further. Therefore, it is possible to protect the display 6.

In this embodiment, the stopper 64 is, for example, a mechanical switch. When the stopper 64 comes into contact with the rear surface of the display 6, the stopper 64, which is a switch, is operated. When the stopper 64 is operated, a warning message or image for the user may be displayed on a display screen 8 of the electronic apparatus 31.

According to this structure, similarly to the first embodiment, it is possible to improve the heat dissipation performance and protect the display 6. In this embodiment, the stopper 64 prevents the display 6 from being bent at a large angle. Therefore, it is possible to further improve the protection of the display 6.

### Fifteenth Embodiment

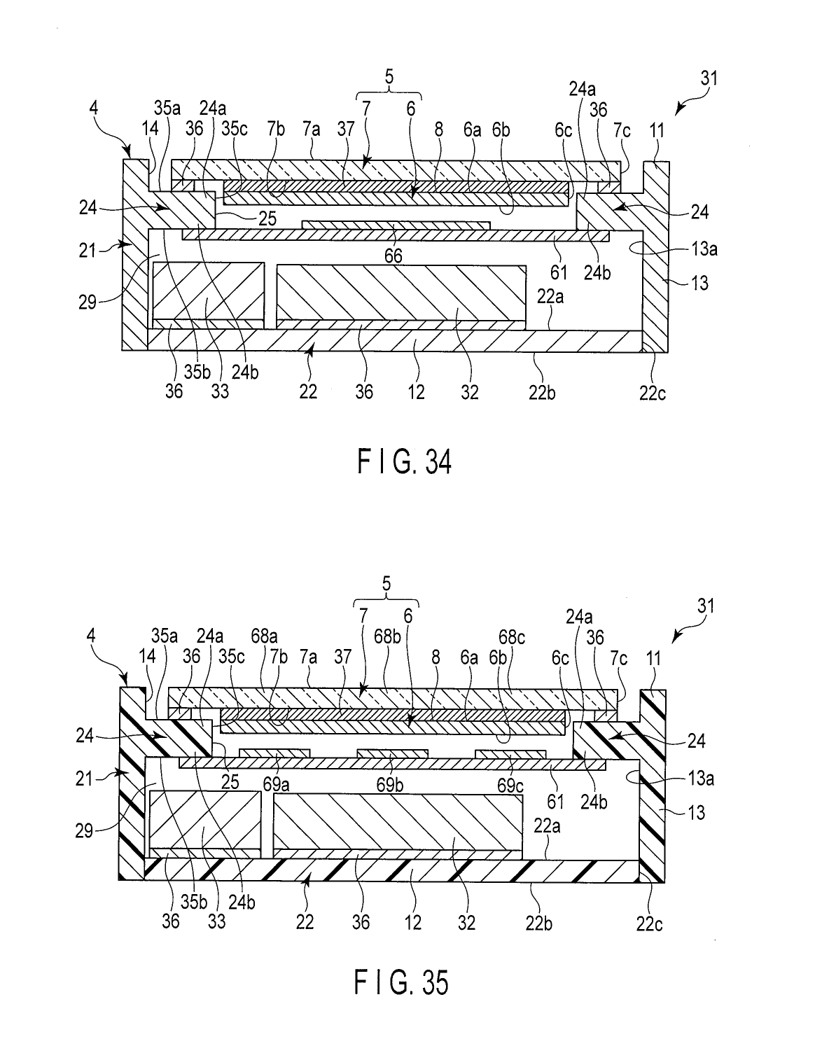

Next, an electronic apparatus 31 according to a fifteenth embodiment will be described with reference to FIG. 34. In the fifteenth embodiment, components having the same or similar functions as those in the first to fourteenth embodiments are denoted by the same reference numerals and the description thereof will not be repeated. Structures other than the following structures are the same as those in the third embodiment.

As illustrated in FIG. 34, in this embodiment, a housing 4 (i.e., a front mask 21 and a rear cover 22) is made of metal. The electronic apparatus 31 includes a supporting member 61 that is provided in the housing 4 and an antenna 66 that is supported by the supporting member 61. At least a portion of the antenna 66 is inserted into a second opening 25 and is disposed inside the second opening 25. The antenna 66 faces a rear surface 6b of a display 6. The antenna 66 transmits and receives radio waves through a display unit 5. An example of the antenna 66 is an antenna for near field communication (NFC) and has a maximum communication distance of several centimeters.

According to this structure, similarly to the first embodiment, it is possible to improve the heat dissipation performance and protect the display 6. In this embodiment, the second opening 25 is used to arrange the antenna 66. This contributes to achieving high-density mounting in the electronic apparatus 31 and reducing the thickness and size of the electronic apparatus 31.

### Sixteenth Embodiment

Next, an electronic apparatus 31 according to a sixteenth embodiment will be described with reference to FIG. 35. In the sixteenth embodiment, components having the same or similar functions as those in the first to fifteenth embodiments are denoted by the same reference numerals and the description thereof will not be repeated. Structures other than the following structures are the same as those in the third embodiment.

As illustrated in FIG. 35, in this embodiment, a display screen 8 includes a first region 68a, a second region 68b, and a third region 68c. The electronic apparatus 31 includes a supporting member 61 that is provided in a housing 4 and vibrators (i.e., vibration generating portions) 69a, 69b, and 69c that are supported by the supporting member 61. Each of the vibrators 69a, 69b, and 69c is, for example, a sheet-type vibrator using a piezoelectric element. However, other types of vibrators, such as motor-type vibrators, may be used.

At least a portion of each of the vibrators 69a, 69b, and 69c is inserted into a second opening 25 and is disposed inside the second opening 25. The vibrators 69a, 69b, and 69c face a rear surface 6b of a display 6. The first vibrator 69a is provided at a position corresponding to the first region 68a of the display screen 8 and is disposed between the first region 68a of the display screen 8 and a rear cover 22. The second vibrator 69b is provided at a position corresponding to the second region 68b of the display screen 8 and is disposed between the second region 68b of the display screen 8 and the rear cover 22. The third vibrator 69c is provided at a position corresponding to the third region 68c of the display screen 8 and is disposed between the third region 68c of the display screen 8 and the rear cover 22.

According to the electronic apparatus having the above-mentioned structure, similarly to the first embodiment, it is possible to improve the heat dissipation performance and protect the display 6. In this embodiment, the second opening 25 is used to arrange the vibrators 69a, 69b, and 69c. This contributes to achieving high-density mounting in the electronic apparatus 31 and reducing the thickness and size of the electronic apparatus 31. In addition, since the vibrators 69a, 69b, and 69c are provided so as to correspond to the regions 68a, 68b, and 68c of the display screen 8, respectively, the user can perform an intuitive operation. This contributes to improving user convenience.

### Seventeenth Embodiment

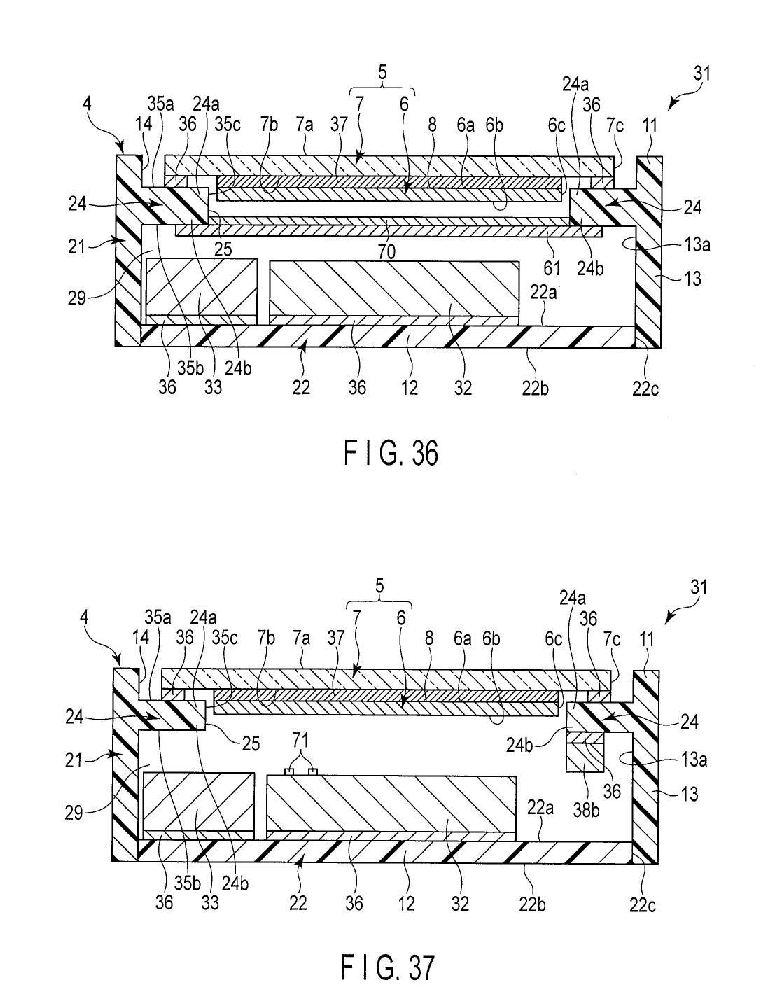

Next, an electronic apparatus 31 according to a seventeenth embodiment will be described with reference to FIG. 36. In the seventeenth embodiment, components having the same or similar functions as those in the first to sixteenth embodiments are denoted by the same reference numerals and the description thereof will not be repeated. Structures other than the following structures are the same as those in the third embodiment.

As illustrated in FIG. 36, in this embodiment, a display 6 (i.e., first display) is, for example, a semi-transmissive display and the rear side of the display 6 is transparent when the display 6 is turned off. In this embodiment, the electronic apparatus 31 includes a supporting member 61 that is provided in a housing 4 and a display 70 (i.e., a second display or a functional portion) that is supported by the supporting member 61. The second display 70 is, for example, a seal indicating specific content, function, or warning, or a mark or a logo related to a product, but is not limited thereto. The second display 70 may be, for example, a mirror.

At least a part of the display 70 is inserted into a second opening 25 and is disposed inside the second opening 25. The second display 70 faces a rear surface 6b of the display 6. With the display 6 turned off, the display 70 is viewed from the outside through the display 6.

According to the electronic apparatus having the above-mentioned structure, similarly to the first embodiment, it is possible to improve the heat dissipation performance and protect the display 6. In this embodiment, the second opening 25 is used to arrange the display 70. This contributes to achieving high-density mounting in the electronic apparatus 31 and reducing the thickness and size of the electronic apparatus 31. The display 70 makes it possible to improve user convenience.

### Eighteenth Embodiment

Next, an electronic apparatus 31 according to an eighteenth embodiment will be described with reference to FIG. 37. In the eighteenth embodiment, components having the same or similar functions as those in the first to seventeenth embodiments are denoted by the same reference numerals and the description thereof will not be repeated. Structures other than the following structures are the same as those in the third embodiment.

As illustrated in FIG. 37, in this embodiment, a display 6 is, for example, a semi-transmissive display and the rear side of the display 6 is transparent when the display 6 is turned off. In this embodiment, a battery 32 includes, for example, an indicator 71 indicating the level of the battery 32. The indicator 71 faces a rear surface 6b of the display 6. Therefore, with the display 6 turned off, the indicator 71 of the battery 32 is viewed from the outside through the display 6. In this embodiment, the indicator 71 is provided in the battery 32, but the embodiments are not limited thereto. The indicator 71 may be provided in other components.

According to this structure, similarly to the first embodiment, it is possible to improve the heat dissipation performance and protect the display 6. In this embodiment, since the semi-transmissive display 6 is used, the indicator 71 of the battery 32 can be viewed from the outside. In this way, it is possible to improve user convenience.

### Nineteenth Embodiment

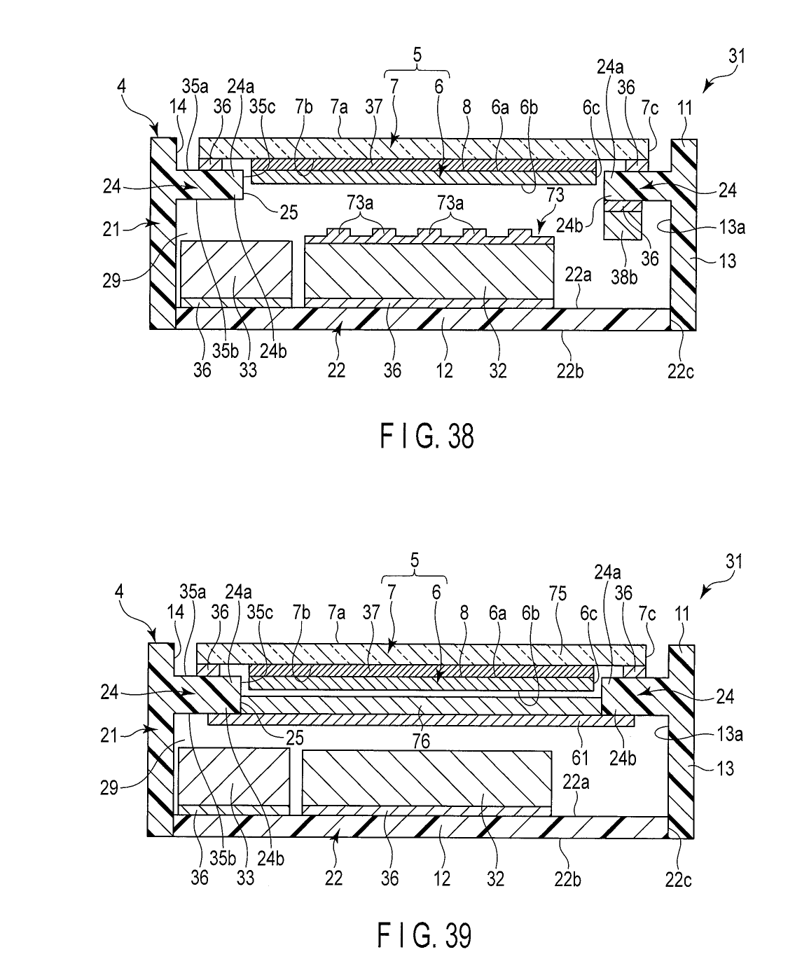

Next, an electronic apparatus 31 according to a nineteenth embodiment will be described with reference to FIG. 38. In the nineteenth embodiment, components having the same or similar functions as those in the first to eighteenth embodiments are denoted by the same reference numerals and the description thereof will not be repeated. Structures other than the following structures are the same as those in the third embodiment.

As illustrated in FIG. 38, in this embodiment, a battery 32 is an example of a heat generating component. A heat dissipating portion 73 (i.e., heat dissipating member) is provided on the battery 32. The heat dissipating portion 73 faces a second opening 25. The heat dissipating portion 73 includes a plurality of protrusions 73a protruding toward the second opening 25.

According to this structure, similarly to the first embodiment, it is possible to improve the heat dissipation performance and protect the display 6. In this embodiment, the heat dissipating portion 73 including the protrusions 73a which protrude toward the second opening 25 is provided. In this way, a gap (i.e., space) formed by the second opening 25 is used to further improve the heat dissipation performance of the electronic apparatus 31.

### Twentieth Embodiment

Next, an electronic apparatus 31 according to a twentieth embodiment will be described with reference to FIG. 39. In the twentieth embodiment, components having the same or similar functions as those in the first to nineteenth embodiments are denoted by the same reference numerals and the description thereof will not be repeated. Structures other than the following structures are the same as those in the third embodiment.

As illustrated in FIG. 39, in this embodiment, the electronic apparatus 31 includes a first touch sensor 75 (i.e., a first sensor portion or a first touch panel) and a second touch sensor 76 (i.e., a second sensor portion or a second touch panel). The first touch sensor 75 is, for example, a pressure-sensitive touch sensor. The first touch sensor 75 faces a front surface 6a of a display 6. The first touch sensor 75 is provided in a first opening 14 and is exposed to the outside of the housing 4.

The second touch sensor 76 is, for example, a capacitive touch sensor. At least a portion of the second touch sensor 76 is inserted into the second opening 25 and is disposed inside the second opening 25. The second touch sensor 76 faces the rear surface 6b of the display 6.

According to this structure, similarly to the first embodiment, it is possible to improve the heat dissipation performance and protect the display 6. In this embodiment, the second opening 25 is used to arrange the second touch sensor 76. This contributes to achieving high-density mounting in the electronic apparatus 31, reducing the thickness and size of the electronic apparatus 31, and improving user convenience.

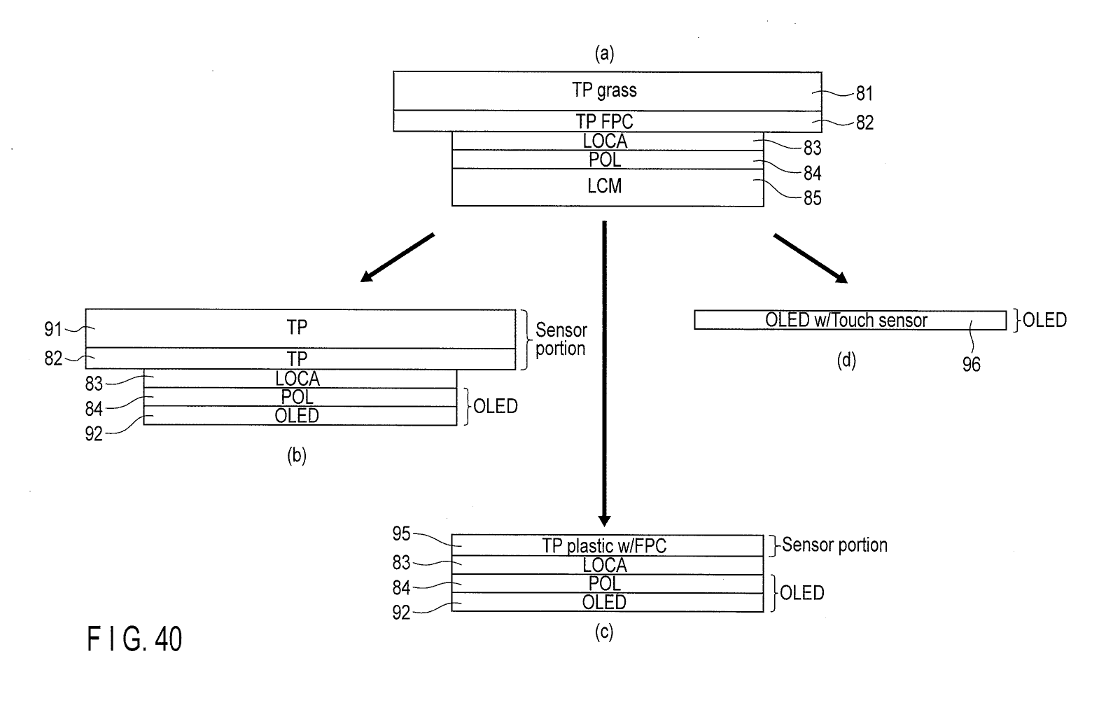

Next, some modifications of the display unit 5 which can be applied to any one of the first to twentieth embodiments will be described with reference to FIG. 40. A display unit 5 illustrated in (a) of FIG. 40 includes a glass panel 81, a touch panel 82, light-permeable adhesive portion 83, a polarizing plate 84, and a liquid crystal display 85.

A display unit 5 illustrated in (b) of FIG. 40 differs from the display unit 5 illustrated in (a) of FIG. 40 in that the glass panel 81 is changed to a plastic panel 91 and the liquid crystal display 85 is changed to an organic EL display 92. That is, the display unit 5 illustrated in (b) of FIG. 40 includes the plastic panel 91, the touch panel 82, the light-permeable adhesive portion 83, the polarizing plate 84, and the organic EL display 92.

A display unit 5 illustrated in (c) of FIG. 40 differs from the display unit 5 illustrated in (a) of FIG. 40 in that it does not include the glass panel 91. The display unit 5 illustrated in (c) of FIG. 40 includes a plastic panel 95 provided with a touch sensor, the light-permeable adhesive portion 83, the polarizing plate 84, and the organic EL display 92.

A display unit 5 illustrated in (d) of FIG. 40 differs from the display unit 5 illustrated in (a) of FIG. 40 in that it does not include the glass panel 91 and it is an in-cell touch panel type. The display unit 5 illustrated in (d) of FIG. 40 includes an organic EL display 96 provided with a touch sensor.

The embodiments are not limited to the above-described embodiments, but the components according to the above-described embodiments may be changed without departing from the scope and spirit of the invention. In addition, a plurality of components according to the above-described embodiments may be appropriately combined with each other to form various structures. For example, some of the components according to the above-described embodiments may be removed. Components according to different embodiments may be appropriately combined with each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television comprising:
a display comprising a front surface, a rear surface, and a side surface;
a light-permeable panel comprising a touch sensor and configured to face the front surface of the display;
a rear cover configured to cover the rear surface of the display;
a front mask configured to be exposed to an outside of the television, the front mask comprising:
a front wall comprising an opening configured to expose the light-permeable panel,
a sidewall extending from the front wall toward the rear cover, the sidewall configured to cover a side surface of the rear cover,
a support protruding from an inner surface of the sidewall, the support configured to support at least one of the display and the light-permeable panel, the support comprising:
a first portion configured to face the side surface of the display, and
a second portion extending from the first portion toward the rear cover, the second portion closer to the rear cover than the rear surface of the display; and
a first component between the display and the rear cover, the first component configured to attach to the rear surface of the display along the second portion of the support, the first component configured to contact the second portion.

2. The television of claim 1,
wherein the support protrudes from the inner surface of the sidewall in a direction substantially parallel to the rear surface of the display, and
the support comprises a space configured to accommodate a second component between the support and the rear cover.

3. The television of claim 1,
wherein at least a part of the support is between the display and the rear cover and configured to support the rear surface of the display.

4. The television of claim 1,
wherein the support has an annular shape along the inner surface of the sidewall.

5. The television of claim 4, further comprising:
a third component between the display and the rear cover,
wherein at least a portion of the third component is inside an opening defined by the support.

6. The television of claim 4, further comprising:
a battery case between the display and the rear cover,
wherein at least a portion of the battery case is inside an opening defined by the support and configured to support the rear surface of the display.

7. The television of claim 1,
wherein the display comprises a circuit board configured to drive the display, and
the circuit board is between the support and the rear cover and is attached to the support.

8. An electronic apparatus comprising:
a display comprising a front surface, a rear surface, and a side surface;
a rear cover configured to cover the rear surface of the display; and
a front mask comprising:
a front wall comprising an opening configured to expose the front surface of the display,
a sidewall extending from the front wall to the rear cover, and
a support protruding from an inner surface of the sidewall and configured to support the display, the support comprising:
a first portion configured to face the display, and
a second portion closer to the rear cover than the rear surface of the display.

9. The electronic apparatus of claim 8,
wherein at least a part of the support is between the display and the rear cover and configured to support the rear surface of the display.

10. The electronic apparatus of claim 8,
wherein the display is flexible,
the rear cover comprises a first member, a second member, and a first elastic portion between the first member and the second member,
the front mask comprises a third member, a fourth member, and a second elastic portion between the third member and the fourth member, the second elastic portion located at a position corresponding to the first elastic portion, and
the electronic apparatus is configured to be bendable at the first elastic portion and the second elastic portion.

11. An electronic apparatus comprising:
a display comprising a front surface, a rear surface, and a side surface;
a rear cover configured to cover the rear surface of the display; and
a front mask configured to be exposed to an outside, the front mask comprising:
an opening configured to expose the front surface of the display, and
a support configured to support the display,
the support comprising:
a first portion configured to face the side surface of the display, and
a second portion protruding from the first portion toward the rear cover, the second portion closer to the rear cover than the rear surface of the display.
